(19) United States
(12) Patent Application Publication
(10) Pub. No.: US 2003/0142818 A1
(43) Pub. Date: Jul. 31, 2003

(54) Techniques for efficient security processing

(75) Inventors: Anand Raghunathan, Princeton, NJ (US); Srivaths Ravi, Princeton, NJ (US); Nachiketh Potlapally, Princeton, NJ (US); Srimat Chakradhar, Princeton, NJ (US); Murugan Sankaradas, Princeton, NJ (US)

Correspondence Address: SUGHRUE MION, PLLC, 2100 Pennsylvania Avenue, NW, Washington, DC, 20037-3213, US

(73) Assignee: NEC USA, INC.

(21) Appl. No.: 10/259,569

(22) Filed: Sep. 30, 2002

Related U.S. Application Data
(60) Provisional application No. 60/325,189, filed on Sep. 28, 2001.
(60) Provisional application No. 60/342,748, filed on Dec. 28, 2001.
(60) Provisional application No. 60/361,276, filed on Mar. 4, 2002.

(51) Int. Cl. H04K 3/00

(52) U.S. Cl. 380/1

(57) ABSTRACT

A programmable security processor for efficient execution of security protocols, wherein the instruction set of the processor is enhanced to contain at least one instruction that is used to improve the efficiency of a public-key cryptographic algorithm, and at least one instruction that is used to improve the efficiency of a private-key cryptographic algorithm.

### I.A. RELATED APPLICATIONS

This application claims priority from co-pending U.S. Provisional Patent Application Serial No. 60/325,189 filed Sep. 28, 2001; No. 60/342,748 filed Dec. 28, 2001 and No. 60/361,276 filed Mar. 4, 2002, the disclosures of each of which applications are incorporated herein by reference.

### I. DESCRIPTION

I.B. Field

This disclosure teaches techniques related to hardware and software architecture for efficient security processing. Also disclosed are techniques to design such hardware and software architectures as well as techniques for integrating such software and hardware architecture platforms into a large computing system.

I.C. Background

1. References

The following papers provide useful background information, for which they are incorporated herein by reference in their entirety, and are selectively referred to in the remainder of this disclosure by their accompanying reference numbers in triangular brackets (i.e., <4> for the fourth numbered paper by B. Schneier.):

<1> <1> U. S. Department of Commerce, The Emerging Digital Economy II. http://www.ecommerce.gov/ede/report.html, 1999.

<2> W. W. W. Consortium, The World Wide Web Security FAQ. http://www.w3.org/Security/faq/www-security-faq.html, 1998.

<3> ePaynews—Mobile Commerce Statistics. http://www.epaynews.com/statistics/mcommstats.html.

<4> B. Schneier, Applied Cryptography: Protocols, Algorithms and Source Code in C. John Wiley and Sons, 1996.

<5> W. Stallings, Cryptography and Network Security: Principles and Practice. Prentice Hall, 1998.

<6> S. K. Miller, “Facing the Challenges of Wireless Security,” in IEEE Computer, pp. 46-48, July 2001.

<7> G. Apostolopoulos, V. Peris, P. Pradhan, and D. Saha, “Securing Electronic Commerce: Reducing SSL Overhead,” in IEEE Network, pp. 8-16, July 2000.

<8> D. Boneh and N. Daswani, “Experimenting with Electronic Commerce on the PalmPilot,” in Proc. Financial Cryptography, pp. 1-16, 1999.

<9> K. Lahiri, A. Raghunathan, and S. Dey, “Battery-driven system design: A new frontier in low power design,” in Proc. Joint Asia and South Pacific Design Automation Conf./Int. Conf. VLSI Design, pp. 261-267, January 2002.

<10> A. G. Broscius and J. M. Smith, “Exploiting parallelism in hardware implementation of DES,” in Proc. CRYPTO'91, pp. 367-376, 1991.

<11> A. Curiger, H. Bonnenberg, R. Zimmermann, N. Felber, H. Kaeslin, and W. Fichtner, “VINCI: VLSI implementation of the new secret-key block cipher IDEA,” in Proc. IEEE Custom Integrated Circuits Conf., pp. 15.5.1-15.5.4, May 1993.

<12> C. K. Koc, “RSA hardware implementation,” Tech. Rep. TR-801 (available online at http://security.ece.orst.edu/koc/ece575/rsalabs/tr-801.pdf), RSA Data Security Inc., April 1996.

<13> T. Ichikawa, T. Kasuya, and M. Matsui, “Hardware evaluation of the AES finalists,” in Third Advanced Encryption Standard (AES) Conference, April 2000.

<14> Xtensa application specific microprocessor solutions—Overview handbook. Tensilica Inc. (http://www.tensilica.com), 2001.

<15> A. S. Tanenbaum, Computer Networks. Prentice-Hall, Englewood Cliffs, N.J., 1989.

<16> D. E. Knuth, The Art of Computer Programming: Seminumerial Algorithms. Addison Wesley, 1981.

<17> J. J. Quisquater and C. Couvreur, “Fast Decipherment algorithm for RSA public-key cryptosystems,” in Electronic Letters, pp. 905-907, October 1982.

<18> R. L. Rivest, “Rsa chips (past/present/future),” in Proc. EUROCRYPT, 1984.

<19> P. L. Montgomery, “Modular multiplication without trial division,” in Mathematics of Computation, pp. 519-521, 1985.

<20> S. R. Dusse and B. S. Kaliski, “A Cryptographic Library for the Motorola DSP 5600,” in Proc. EUROCRYPT, pp. 230-244, 1991.

<21> T. Granlund, The GNU Multiple Precision Arithmetic Library. http://www.gnu.org, 2000.

<22> W. N. Venables and B. D. Ripley, Modern Applied Statistics with S-PLUS. Springer-Verlag, 1998.

<23> “Design Compiler, Synopsys Inc. (http://www.synopsys.com).”.

<24> CB-11 Family 0.18 um CMOS Cell-based IC Design Manual. NEC Electronics, Inc., December. 1999.

<25> Xtensa Microprocessor Emulation Kit XT 2000—User's Guide. Tensilica Inc. (http://www.tensilica.com), 2001.

<26> S1D13806 Embedded Memory Display Controller. Epson Research & Development Inc. (http://www.erd.epson.com).

<27> NL6448BC33-31 10.4 inch digital VGA LCD display. NEC Electronics Inc. (http://www.necel.com).

<28> Intel Corp., Enhancing Security Performance through IA-64 Architecture. http://developer.intel.com/design/security/rsa2000/itanium.pdf, 2000.

<29> K. Kant, R. Iyer, and P. Mohapatra, “Architectural Impact of Secure Sockets Layer on Internet Servers,” in Proc. Int. Conf. Computer Design, pp. 7-14, 2000.

<30> A. Goldberg, R. Buff, and A. Schmitt, “Secure Server Performance Dramatically Improved by Caching SSL Session Keys,” in ACM Wksp. Internet Server Performance, June 1998.

<31> M. Rosing, Implementing Elliptic Curve Cryptography. Manning Publications Co., 1998.

<32> NTRU Communications and Content Security. http://www.ntru.com.

<33> Broadcom Corporation, BCM5840 Gigabit Security Processor. http://www.broadcom.com.

<34> Corrent Inc. http://www.corrent.com.

<35> HIFN Inc. http://www.hifn.com.

<36> Motorola Inc., MC190:Security Processor. http://www.motorola.com.

<37> NetOctave Inc. http://www.netoctave.com.

<38> Securealink USA Inc. http://www.securealink.com.

<39> ARM SecurCore. http://www.arm.com.

<40> SmartMIPS. http://www.mips.com.

<41> Z. Shi and R. Lee, “Bit Permutation Instructions for Accelerating Software Cryptography,” in Proc. IEEE Intl. Conf. Application-specific Systems, Architectures and Processors, pp. 138-148, 2000.

<42> J. Burke, J. McDonald, and T. Austin, “Architectural Support for Fast Symmetric-Key Cryptography,” in Proc. Intl. Conf. ASPLOS, pp. 178-189, November 2000.

<43> Wireless Application Protocol 2.0—Technical White Paper. WAP Forum (http://www.wapforum.org/), January 2002.

<44> S. Okazaki, A. Takeshita, and Y. L. Lin, “New trends in mobile phone security,” in Proc. RSA Conference (http://www.rsasecurity.com/conference/), April 2001.

2. Introduction

A large fraction of the applications and services that are of interest to Internet users involve access to, and transmission of, sensitive information (e.g., e-commerce, access to corporate data, virtual private networks, online banking and trading, multimedia conferencing, etc.), making security a serious concern <1, 2>. The deployment of high-speed wireless data and multi-media communications ushers in even greater security challenges. Wireless communication relies on the use of a public transmission medium, making the physical signal easily accessible to malicious entities. Surveys of current and potential users of mobile commerce (m-commerce) services have indicated security concerns as the single largest bottleneck to their adoption <3>.

Several security mechanisms have been developed for wired and wireless networks, based on providing security enhancements to various layers of the protocol stack (e.g., IPSec at the network layer, SSL/TLS and WTLS at the transport layer, SET at the application layer, etc.) <4, 5>. While the above mechanisms provide satisfactory security if utilized appropriately, there is a critical bottleneck that impedes their use to address security concerns in wireless networks. Wireless clients (e.g., smart phones, PDAs) are, and will always be, much more resource (processing capability, battery) constrained than their wired counterparts. On the other hand, security protocols significantly increase computational requirements at the network clients and servers <6, 7, 8> to levels that exceed the capabilities of wireless handsets. For example, a PalmIIIx™ handset requires around 3.4 minutes to perform 512-bit RSA key generation, around 7 seconds to perform digital signature generation, and can perform (single) DES encryption at only around 13kbps, assuming that the CPU is completely dedicated to security processing <8>. Further, security processing has been reported to rapidly drain the Palm's batteries <8>. The increase in data rates (due to advances in wireless communication technologies), and the use of stronger cryptographic algorithms (to stay beyond the extending reach of malicious entities) threaten to further widen the gap between security processing requirements and embedded processor performance (the “security processing gap”).

FIG. 1 compares the projected trends in computational requirements (MIPS) for security processing, and the increase in embedded processor performance (enabled by improvements in fabrication technology and innovations in embedded processor architecture). The inadequate performance of embedded processors in processing security protocols leads to high network transaction latencies, and low effective data rates. Another critical bottleneck to security processing on wireless handsets is battery capacity, whose growth (5-8% per year) is far slower than the growth in processing requirements or processor performance <9>. In practice, various metrics such as performance, power, and cost, need to be considered together and it is their interaction that poses the toughest challenges to the system designer. For example, power and cost are the main reasons why embedded processors for wireless handsets are slower than their desktop counterparts. Algorithm-specific custom hardware implementations can always provide the highest levels of efficiency <10, 11, 12, 13>. However, in practice, the need for efficiency in security processing has to often be considered together with, and traded off against, the need for flexibility. Each security protocol standard typically specifies a wide range of cryptographic algorithms that the network servers and clients need to execute in order to facilitate inter-operability <4, 5>. Further, a security processor is often required to execute multiple distinct security protocol standards in order to support (i) security processing in different layers of the network protocol stack (e.g., WEP, IPSec, and SSL), or (ii) inter-working among different networks (e.g., an appliance that needs to work in both 3G cellular and wireless LAN environments). Finally, programmability is desirable in order to allow easy adaptation to future security protocols and evolving standards. Hence, novel technologies to alleviate the computational burden of security processing while maintaining sufficient programmability are required.

I.D. General Background Information

Wireless data communications can be secured by employing security protocols that are added to various layers of the protocol stack, or within the application itself. The role of security mechanisms and protocols is to ensure privacy and integrity of data, and authenticity of the parties involved in a transaction. In addition, it is also desirable to provide functionality such as non-repudiation, preventing the use of handsets in denial-of-service attacks, filtering of viruses and malicious code, and in some cases, anonymous communication. It is important to recognize that wireless security is an end-to-end requirement, and can be sub-divided into various security domains.

Appliance domain security attempts to ensure that only authorized entities can use the appliance, and access or modify the data stored on it.

Network access domain security ensures that only authorized devices can connect to a wireless network or service, and ensures data privacy and integrity over the wireless link.

Network domain security addresses security of the infrastructure (voice and data) networks that support a wireless network. Infrastructure networks are typically wired, could include public networks, and could span networks owned by multiple carriers.

Application domain security ensures that only safe and trusted applications can execute on the appliance, and that transactions between applications executing on the client and application servers across the Internet are secure.

Security protocols utilize cryptographic algorithms (asymmetric or public-key ciphers, symmetric or private-key ciphers, hashing functions, etc.) as building blocks in a suitable manner to achieve the desired objectives (peer authentication, privacy, data integrity, etc.). In the wired Internet, the most popular approach is to use security protocols at the network or IP layer (IPSec), and at the transport or TCP layer (TLS/SSL) <4,5>. In the wireless world, the range of security protocols is broader. Different security protocols have been developed and employed in cellular technologies such as CDPD and GSM, wireless local area network (WLAN) technologies such as IEEE 802.11, and wireless personal area network technologies such as Bluetooth. Many of these protocols address only network access domain security, i.e., securing the link between a wireless client and the access point, base station, or gateway. Several studies have shown that the level of security provided by most of the above security protocols may be insufficient, and that they can be easily broken or compromised by serious hackers. While some of these drawbacks are being addressed in newer wireless standards such as 3GPP and 802.11 enhancements, it is generally accepted that they need to be complemented through the use of security mechanisms at higher protocol layers. With the push to bring wired Internet data and applications to wireless handsets, and to enhance the wireless data experience, conventional Internet protocols are being increasingly used in wireless networks, by overlaying them on top of the underlying “bearer” technologies. This is leading to an increased adoption of widely accepted Internet security protocols to secure wireless data as well.

To illustrate how various security protocols fit into the context of a wireless handset, we consider a wireless network that uses the Wireless Application Protocol (WAP) <43>, in which a wireless client communicates with a web server across the Internet, through a base station and a wireless gateway. The WAP standard defines protocols for the wireless link, which can be overlaid on top of existing wireless bearer technologies, such as GSM, CDPD, CDMA, etc. The WAP gateway translates traffic to/from the wireless handset (which uses the WAP protocol stack), to conventional Internet protocols (HTTP/TCP/IP), thereby facilitating inter-working with existing Internet servers. The network architecture described above allows for the use of security schemes at multiple layers of the protocol stack.

Security protocols provided in the bearer technologies (such as CDPD, GSM, CDMA, etc.) may be used to provide network access domain security, including user authentication to the serving network, as well as a basic level of confidentiality and integrity over the wireless link. Note that, these security protocols may be employed for both voice and data, and independent of the nature of the data or application. However, as mentioned earlier, security protocols used in bearer technologies are may be insufficient for data requiring high levels of security. Moreover, these techniques do not address the problem of maintaining end-to-end security across the wired infrastructure network.

The WAP protocol stack includes a transport-layer security protocol, called WTLS, which provides higher layer protocols and applications with a secure transport service interface and secure connection management functions. WTLS bears similarities to the Internet security standard TLS/SSL, while including additional features such as datagram support, optimized handshake, and dynamic key refresh.

Finally, specific applications may decide to directly employ security mechanisms instead of, or in addition to, the aforementioned options (through an application-level security protocol such as SET <4,5>, or to provide additional functionality, such as non-repudiation, that is not provided in the transport-layer security protocol).

A well known concern with the WAP security architecture is the existence of a “security gap” at the wireless gateway, which arises since the translation between different transport-layer security protocols causes data to exist in decrypted form. This problem can be somewhat alleviated by maintaining the WAP gateway within a secure network domain (e.g., behind the same firewall as the web server). Alternatively, the use of an end-to-end security protocol between the wireless handset and wired server eliminates this problem. For example, NTT DoCoMo's iMode service uses SSL to secure end-to-end connections <44>, and the recently released WAP 2.0 specification <43> includes a new mode that uses standard Internet protocols (HTTP/TLS/TCP/IP) between the wireless client and a server across the Internet.

1. Background Information in Public-key Algorithms

Public-key algorithms (also known as asymmetric algorithms) perform two basic tasks: key generation and encryption or decryption. Key generation consists of generating the “private key” and the “public key”, which are used in the encryption and decryption of input data. The “public key” is disclosed to the world, whereas the “private key” is kept secret by the legitimate owner of the keys. It should be noted that the terms private-key algorithms and symmetric-key algorithms are used interchangeably in the Specification. Likewise, encryption algorithms, cryptography algorithms and cipher are used interchangeably.

The key generation step is typically performed quite infrequently. Encryption/decryption constitutes bulk of the work done by a public-key cryptographic algorithm. Thus, any attempts to improve public-key algorithm performance should target this stage. In most public key algorithms (e.g., RSA, El Gamal, Diffie-Hellman, etc.), encryption/decryption is performed using modular exponentiation (using the private key or the public key). Therefore, an optimization targeting modular exponentiation becomes applicable to a wide range of public-key algorithms.

Key generation consists of determining three quantities: the modulus (n), the public exponent (e) and the private exponent (d). The two tuples (e,n) and (d,n) constitute the public and the private key, respectively. To encrypt a message m (plaintext), we divide m into blocks (m[1], m[2] . . . , M[p]). Then, encryption is performed through modular exponentiation, defined by

c[i]=m[i]^{e} mod n, for i=1 to p

where, c[i] is the cipher text block corresponding to m[i]. To decrypt a message, we take each encrypted block,c[i], and compute

m[i]=c[i]^{d} mod n, for i=1 to p

I.B. Related Work

The security processing gap is simply a mismatch between the computational workload demanded by security protocols and the computational horsepower supplied by the processor in the system. Several attempts have been made to lower this gap either by making the security protocols and their constituent cryptographic algorithms lightweight, or by enhancing the security processing capabilities of the processor. Most of the efforts towards improving the efficiency of security processing have been targeted at addressing performance issues in e-commerce servers, network routers, firewalls, and VPN gateways <7, 28, 29, 30>. The fact that public key algorithms often dominate security processing requirements has driven the recent development of alternative public-key algorithms that offer reduced computational complexity <31, 32>. Various companies offer commercial security processor ICs to improve the performance of transaction servers and network routers <33, 34, 35, 36, 37, 38>. Architectural enhancements to high-end microprocessor systems to improve their performance in security processing have been investigated <28, 29>. Embedded processor designers have also developed security extensions to their products, typically based on the addition of application-specific co-processors and/or peripherals <39, 40>. Computer architects have researched domain specific instructions for private-key encryption algorithms, with an aim to maximize efficiency without compromising programmability <41, 42>. Our target architecture and the system-level design methodologies presented here are complementary to most of the above efforts, and can enable high efficiency in security processing while maintaining programmability.

### II. SUMMARY

The disclosed teachings are aimed at overcoming some of the disadvantages and solving some of the problems in relation to conventional technologies.

A programmable security processor for efficient execution of security protocols. The instruction set of the processor is enhanced to contain at least one instruction that is used to improve the efficiency of a public-key cryptographic algorithm. At least one instruction that is used to improve the efficiency of a private-key cryptographic algorithm is also provided.

Other aspects of the present disclosure are also provided. Further, more specific enhancements are also provided, as should be clear from the claims as well as from the detailed description.

### III. BRIEF DESCRIPTION OF THE DRAWINGS

The above objectives and advantages of the disclosed teachings will become more apparent by describing in detail preferred embodiments thereof with reference to the attached drawings in which:

FIG. 1 shows a graph illustrating the security processing gap by depicting projected trends in security processing requirements and embedded processor performance.

FIG. 2 presents an overview of the MOSES security processing system architecture which is an exemplary implementation of some of the disclosed techniques.

FIG. 3 shows a call graph for a modular exponentiation algorithm.

FIG. 4 shows effect of (a) input block size, (b) CRT, (c) MM algorithm, and (d) radix size.

FIG. 5 shows effects of caching (pre-ME and intra-MM).

FIG. 6 shows an example of a system that includes a host processor and MOSES as a security processor.

FIG. 7 shows an overview of the security processing system design methodology.

FIG. 8 shows enhanced architectural simulation with pre-characterized software libraries

FIG. 9 depicts a performance profile of function mod(in2,in1) over different input bit-widths.

FIGS. 10(a)-(c) depict different types of A-D curves

FIG. 11 shows the Cartesian product of the points on the A-D curves for functions mpn_add_n and mpn_addmul_{—}1.

FIG. 11 depicts combining the design spaces of two area-delay (A-D) curves.

FIG. 12 shows an example functional prototype of the security processing platform.

FIG. 13 shows estimated speedups for SSL transactions.

FIG. 14 depicts accuracy (cycle count) and efficiency (simulation time) comparisons of the proposed performance estimation methodology with cycle-accurate target simulation.

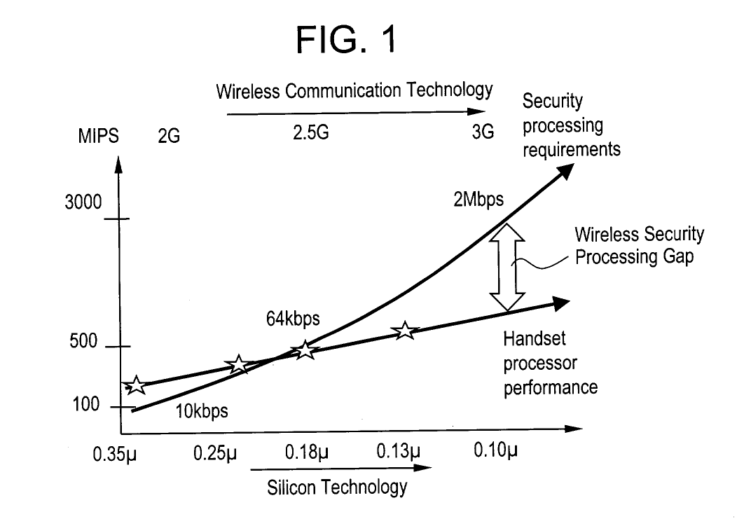

### IV. DETAILED DESCRIPTION

IV.A. Synopsis

As an implementation of the disclosed techniques we have developed a programmable security processor platform called MOSES (MObile SEcurity processing System) to address the challenges of secure data and multi-media communications in wireless handsets. It should be clear that MOSES is merely one non-limiting exemplary implementation of the techniques disclosed in this application and should not be construed in any way to limit the scope of the invention as defined by the claims. A skilled artisan would know that several alternate implementations are possible without deviating from the scope of the invention as defined by the claims.

The addition of MOSES to an electronic system enables secure communications at high data rates, e.g., 3G cellular (100 kbps-2 Mbps) and wireless LAN (10-60 Mbps) technologies, while allowing for easy programmability in order to support a wide range of current and future security protocol standards. As explained above, the growth in computational requirements for security processing outstrips improvements in embedded processor performance, resulting in a significant performance gap. We believe that the use of novel system architectures and system-level design methodologies is critical to bridge this gap.

The system architecture of MOSES consists of

A configurable and extensible processor based hardware architecture that is customized for efficient domain-specific processing, while retaining sufficient programmability, and

Layered software libraries implementing cryptographic algorithms that are optimized and tuned to the underlying hardware platform.

We describe the detailed hardware and software architecture of the MOSES platform, including the features that enable it to achieve high efficiency in security processing. Further, we describe optimized schemes to efficiently integrate MOSES into an electronic system that contains a host processor.

In order to design MOSES, we have developed an advanced system design methodology that is based on the co-design of optimized security processing software and an optimized system architecture. It allows the system designers to efficiently match the software to the characteristics of the hardware platform, and vice-versa. Our methodology includes novel techniques for algorithmic exploration and tuning as well as architecture refinement.

Concurrent development of the security algorithms and the underlying hardware architecture requires that the performance of algorithms be evaluated using either hardware models or instruction set simulation (ISS) models. In such a scenario, algorithmic exploration may be infeasible due to the size of the algorithm space, and the amount of time required to simulate realistic network transactions with hardware models. For example, we estimated that simulating a single transaction of the SSL handshake protocol over a space of 495 RSA algorithm configurations would require over a month of simulation time with ISS models of the XtensaTM processor, on a 440 MhZ Sun Ultra 10 workstation with 1 GB memory. We propose a novel methodology to enable efficient and accurate exploration of the algorithm space, based on automatic performance characterization and macro-modeling of software functions that implement the various atomic steps in the security protocol or cryptographic algorithm.

Architecture exploration is performed in our design flow through the generation and selection of custom instructions that accelerate performance-critical, computation-intensive operations. For programs where several distinct parts (e.g. functions) need to be accelerated through custom instructions, the large number of candidate sets of custom instructions make it difficult to evaluate all possibilities explicitly. The problem is further complicated by the fact that, it is often possible to have several different alternative custom instructions for accelerating a single sub-program, which present a tradeoff between the performance improvement and the overheads incurred by the hardware additions. We have developed techniques to automate the selection of custom instructions from a given candidate set, while considering the performance vs. hardware overhead tradeoffs.

We have evaluated the performance of the security processor platform through extensive system simulations, and through hardware implementation using a prototyping platform. Our experiments demonstrate large performance improvements for cryptographic algorithms (e.g., 31.0× for DES, 33.9× for 3DES, 17.4× for AES, and up to 66.4× for RSA) as well as complete security protocols such as SSL, compared to well-optimized software implementations on a state-of-the-art embedded processor. We believe that advanced system architectures as well as system-level design methodologies, such as the one proposed here, are critical to overcoming the challenges encountered in security processing on wireless handsets.

IV.B. Overview of the Security Processing Platform

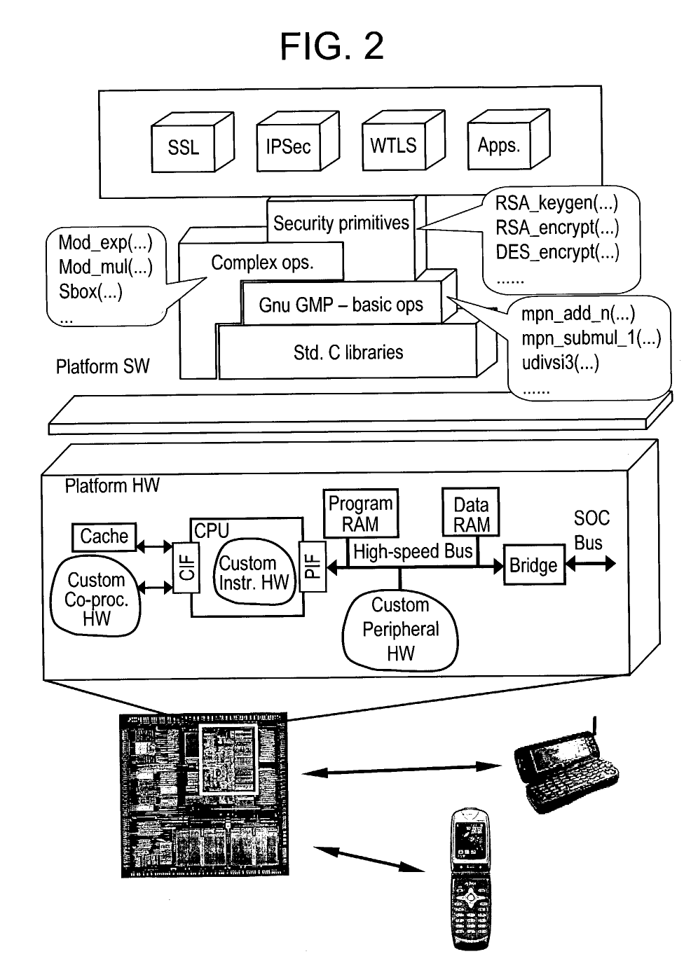

FIG. 2 presents an overview of the MOSES system architecture. Efficient security processing is attained in this architecture through (i) the use of a programmable (configurable and extensible) processor that is customized through the selective addition of custom instructions, co-processors, and peripherals, which implement critical, computation-intensive operations, and (ii) optimized software libraries that are derived through extensive algorithmic exploration and tuning of the security protocols and cryptographic algorithms that they implement.

1. HW Platform Architecture

The hardware platform in MOSES is based on an extensible and configurable processor. The base processor core features a 32-bit RISC-like architecture, which is tuned further through the setting of configuration options, which include selection of generic instructions (e.g., hardware multiplier, MAC, floating point unit, etc.), exceptions and interrupt mechanisms, endianness, register window customization, cache and memory interface configuration, debug and test hardware, etc. Any other processor could similarly be used. The base processor core is further enhanced through the addition of custom instructions (over and above the base processor core instruction set) that execute on designer-specified custom hardware units, which are tightly integrated into the processor execution pipeline. In MOSES, we exploit the customizability of the hardware platform in order to meet our performance objectives for security processing. HW/SW partitioning at the granularity of custom instructions can often result in satisfactory performance improvements. Custom instructions are first derived for implementing carefully selected portions of private-key cryptographic algorithms such as DES, 3DES and AES, as well as, public-key algorithms such as RSA, ECC, Diffie-Hellman and ElGamal used by security protocols, primarily for data confidentiality and user authentication/key exchange. Custom instructions may also be derived for data integrity or message authentication ciphers such as MD5 and SHA, and to implement random number generators needed for deriving the keys used by the cryptographic algorithms. It is important to note that custom instructions for public-key algorithms, private-key algorithms and stage authentication algorithms may be significantly different in nature.

Finally, it is also important to note that speeding up cryptographic algorithms alone may not result in satisfactory speedups of entire security protocols. Hence, MOSES can also include custom instructions to speed up non-cryptographic parts of a security protocol, e.g., packet header parsing, byte order conversion, etc. The advantages of using custom instruction extensions stems from the fact that they allow for ease of integration, and facilitate higher levels of programmability and HW re-use. The different custom instructions also share registers and computational modules for efficient realization of the final extended hardware implementation.

Integration with the processor pipeline also adds area overheads in terms of the modifications to the base processor micro-architecture. Therefore, some coarse-grained functions are mapped to custom hardware, which are integrated as HW co-processors that interface through the cache as well as peripheral units that are connected to the processor or system bus.

2. SW Architecture

The choice of a suitable software architecture is critical to enable an efficient system design methodology. The software architecture for our security processor platform uses a layered philosophy, much like the layering used in the design of network protocols <15>. At the top level, the SW architecture provides a generic interface (API) using which security protocols and applications can be ported to our platform. This API consists of security primitives such as key generation, encryption, or decryption of a block of data using a specific public- or private-key cryptographic algorithm (e.g. RSA, ECC, DES, 3DES, AES, etc.). The security primitive layer is implemented on top of a layer of complex mathematical operations such as modular exponentiation, prime number generation, Miller-Rabin primality testing etc. <4>. The complex operations layer is, in turn, decomposed into basic mathematical operations, including bit-level operations (typically used in private-key algorithms) and multi-precision operations on large integers (typically used in public-key algorithms). The advantages of using the layered SW architecture approach include:

The API interface at each software layer was fixed before implementation, allowing the design of each layer, and the porting of security protocols to our platform, to proceed concurrently. This reduced design time significantly, and enabled the use of more realistic application workloads to drive the design of each SW layer early in the design process.

The separation of the top-level algorithms from the primitives or building blocks that are used to implement them enabled us to characterize the primitives and derive high-level performance macro-models, which were then used for efficient algorithmic exploration. As illustrated by the experimental results we obtained, this novel performance characterization methodology enabled the efficient exploration of large number of candidate algorithms, which would have required several months of simulation time using ISS models.

The generation of candidate custom instructions could proceed once the software layer implementing basic operations was available (i.e., without waiting for the entire SW implementation), since computations of the desired granularity are exposed in the basic operations.

IV. C. Optimizations for the HW Architecture

In this section, we illustrate the optimizations in the HW architecture of MOSES using a public-key algorithm (RSA) and a private-key algorithm (AES) as examples.

1. Implementing Symmetric Encryption Algorithms Using Custom Instructions

We consider the AES encryption algorithm as an example to illustrate how custom instructions can be formulated to result in high efficiency of security processing. Similar techniques are applicable to other symmetric algorithms (ciphers) as well. The design of the algorithm AES (block cipher Rijndael) is well documented in the literature. We used custom instructions to implement different portions of the AES algorithm. The top-level encryption function (function encrypt) is shown below.

void encrypt(char *buff)
{

int i,j,k,m;
WORD a[8],b[8],*x,*y,*t;
for (i=j=0;i<Nb;i++,j+=4)
{

a[i]=pack((BYTE *)&buff[j]);
a[i]\hat{ }=fkey[i];

}
k=Nb;
x=a; y=b;

/* State alternates between a and b */

for (i=1;i<Nr;i++)
{ /* Nr is number of rounds. May be odd. */

/* if Nb is fixed - unroll this next

loop and hard-code in the values of fi[] */

for (m=j=0;j<Nb;j++,m+=3)
{ /* deal with each 32-bit element of the State */
/* This is the time-critical bit */

y[j]=fkey[k++]ftable[(BYTE)x[j]]\hat{ }

ROTL8(ftable[(BYTE) (x[fi[m]]>>8)])\hat{ }
ROTL16(ftable[(BYTE) (x[fi[m+1]]>>16)])\hat{ }
ROTL24(ftable[x[fi[m+2]]>>24]);

}
t=x; x=y; y=t; /* swap pointers */

}

/* Last Round - unroll if possible */

for (m=j=0; j<Nb;j++,m+=3)
{

Y[j]=fkey[k++](WORD)fbsub[(BYTE )x[j]]\hat{ }

ROTL8((WORD)fbsub[(BYTE) (x[fi[m]]>>8)])\hat{ }
ROTL16((WORD)fbsub[(BYTE) (x[fi[m+1]]>>16)])\hat{ }
ROTL24((WORD)fbsub[x[fi[m+2]]>>24]);

}
for (i=j=0;i<Nb;i++,j+=4)
{

unpack(y[i], (BYTE *)&buff[j]);
x[i]=y[i]=0; /* clean up stack */

}
return;

}
© 1999, Mike Scott

© 1999, Mike Scott¹ ¹ The original copyright notice contained the following statement: Permission for free direct or derivative use is granted subject to compliance with any conditions that the originators of the algorithm place on its exploitation.

The computations shown in bold are selected to be implemented as a single custom instruction. The single custom instruction basically needs to perform a combination of xors (corresponding to \hat{ } operations), shifts(corresponding to >> operations), table look-ups (corresponding to fb-sub) and rotates(corresponding to the functions ROTL8, ROTL16 and ROTL24, which rotate 32-bit words left by 1, 2 or 3 bytes, respectively). Implementation of this custom instruction also require special user registers to hold operands needed by the custom computations, and, hence, the associated custom load and store instructions, as well.

In addition to functionality in the top-level encryption functions, we also use custom instructions to implement functionality in the key scheduler (function gkey).

void gkey(int nb,int nk,char *key)

| | |
|---|---|
| { /* blocksize=32*nb bits. Key=32*nk bits | */ |
| /* currently nb,bk = 4, 6 or 8 | */ |
| /* key comes as 4*Nk bytes | */ |

int i,j,k,m,N;
int C1,C2,C3;
WORD CipherKey[8];
Nb=nb; Nk=nk;

/* Nr is number of rounds */

| | |
|---|---|
| if (Nb>=Nk) | Nr=6+Nb; |
| else | Nr=6+Nk; |

| C1=1; | |
|---|---|
| if (Nb<8) | { C2=2; C3=3; } |
| else | { C2=3; C3=4; } |

/* pre-calculate forward and reverse increments */

for (m=j=0;j<nb;j++,m+=3)
{

fi[m]=(j+C1)%nb;
fi[m+1]=(j+C2)%nb;
fi[m+2]=(j+C3)%nb;
ri[m]=(nb+j−C1)%nb;
ri[m+1]=(nb+j−C2)%nb;
ri[m+2]=(nb+j−C3)%nb;

}
N=Nb* (Nr+1);
for (i=j=0;i<Nk;i++,j+=4)
{

CipherKey[i]=pack((BYTE *)&key[j]);

}
for (i=0;i<Nk;i++) fkey[i]=CipherKey[i];
for (j=Nk,k=0;j<N;j+=Nk,k++)
{

fkey[j]=fkey[j-Nk]\hat{ }SubByte(ROTL24(fkey[j-1])) \hat{ }rco[k];
if (Nk<=6)
{

for (i=1;i<Nk && (i+j) <N;i++)

fkey[i+j]=fkey[i+j−Nk]\hat{ }fkey[i+j−1];

}
else
{

for (i=1;i<4 &&(i+j) <N;i++)

fkey[i+j]=fkey[i+j−Nk]\hat{ }fkey[i+j−1];

if ((j+4)<N) fkey[j+4]=fkey[j+4−

Nk]\hat{ }SubByte(fkey[j+3]);

for (i=5;i<Nk && (i+j)<N;i++)

fkey[i+j]=fkey[i+j−Nk]\hat{ }fkey[i+j−1];

}

}

/* now for the expanded decrypt key in reverse order */

for (j=0;j<Nb;j++) rkey[j+N−Nb]=fkey[j];
for (i=Nb;i<N−Nb;i+=Nb)
{

k=N−Nb−i;
for (j=0;j<Nb;j++) rkey[k+j]=InvMixCol(fkey[i+j]);

}
for (j=N−Nb;j<N;j++) rkey[j−N+Nb]=fkey[j];

}
© 1999, Mike Scott

Functions SubByte and InvMixCol are good choices for implementation as custom instructions since they are invoked multiple times in loop nests and can be implemented with very low overheads in hardware. Therefore, these functions are completely implemented as custom instructions. These functions are shown below.

static WORD SubByte(WORD a)
{

BYTE b[14];
unpack (a, b);
b[0]=fbsub[b[0]];
b[1]=fbsub[b[1]];
b[2]=fbsub[b[2]];
b[3]=fbsub[b[3]];
return pack(b);

}
static WORD InvMixCol(WORD x)
{ WORD y,m;

BYTE b[4];
m=pack(InCo);
b[3]=product(m,x);
m=ROTL24(m);
b[2]=product(m,x);
m=ROTL24(m);
b[1]=product(m,x);
m=ROTL24(m);
b[0]=product(m,x);
y=pack(b);
return y;

}
© 1999, Mike Scott

In the above descriptions, function pack is used to pack bytes into a 32-bit word, while function unpack is used to unpack bytes from a word. The function product performs the dot product of two four byte arrays.

2. Implementing Asymmetric Encryption Algorithms Using Custom Instructions

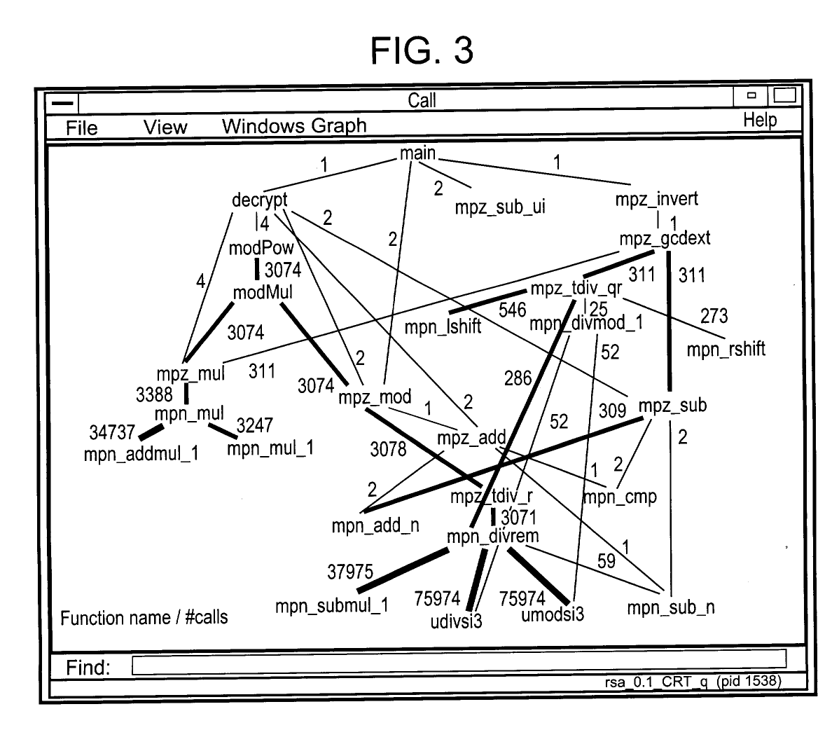

FIG. 3 shows a call graph for a modular exponentiation algorithm. We consider the RSA algorithm, which is a popularly used asymmetric encryption algorithm, to illustrate the features of the MOSES architecture. Similar optimizations of MOSES can be easily applied to result in high processing efficiency for many other asymmetric encryption algorithms.

There are a number of operations in the SW implementation of the RSA, which are good candidates for implementation as custom instructions. The source code of the basic RSA decryption function is shown as a call graph in FIG. 3. Basic operations used in the call graph are arithmetic operations that operate on operands of arbitrary sizes (organized into lists of limbs). Since the basic operations layer are the leaves of the call graph, they accelerate the entire range of applications (not restricted to RSA alone) that use these libraries. Custom instructions were developed for these basic operations.

mpn_add_n: This operation adds together two multi-bit operands. The functionality of mpn_add_n is described below.

mpn_add_n (mp_ptr res_ptr, mp_srcptr s1_ptr, mp_srcptr s2_ptr,
mp_size_t size)
{
register mp_limb_t x, y;
register mp_size_t j;
mp_limb_t cy;

j = −size;
s1_ptr −= j;
s2_ptr −= j;
res_ptr −= j;
cy = 0;
do
{

y = s2_ptr[j];
x = s1_ptr[j];
y += cy;
cy = (y < cy);
y = x + y;
cy = (y < x) + cy;
res_ptr[j] = y;

}
while (++j != 0);
return cy;

}
© 1996, Free Software Foundation

© 1996, Free Software Foundation² ² The original copyright message of the Free Software Foundation included the following statement: The GNU MP Library is free software; you can redistribute it and/or modify it under the terms of the GNU Library General Public License as published by the Free Software Foundation; either version 2 of the License, or (at your option) any later version.

mpn_sub_n: This operation subtracts one multi-bit operand from another. The C code describing the functionality is shown below. As seen from the functionality of mpn_sub_n and mpn_add_n, the corresponding custom instructions can share all the hardware resources needed to implement the instructions by using an arithmetic unit that implements both addition and subtraction.

mpn_sub_n (mp_ptr res_ptr, mp_srcptr s1_ptr, mp_srcptr s2_ptr,
mp_size_t size)
{
register mp_limb_t x, y;
register mp_size_t j;
mp_limb_t cy;

j = −size;
s1_ptr −= j;
s2_ptr −= j;
res_ptr −= j;
cy = 0;
do
{

y = s2_ptr[j];
x = s1_ptr[j];
y += cy;
cy = (y < cy);
y = x − y;
cy = (y > x) + cy;
res_ptr[j] = y;

}
while (++j != 0);
return cy;

}
© 1996, Free Software Foundation

mpn_mul_{—}1: This operation multiplies a multi-bit operand with a single 32-bit limb. The C code implementing this operation is as follows.

mp_limb_t mpn_mul_1 (res_ptr, s1_ptr, s1_size, s2_limb)
register mp_ptr res_ptr;
register mp_srcptr s1_ptr;
mp_size_t s1_size;
mp_limb_t s2_limb;
{

mp_limb_t cy_limb;
register mp_size_t j;
register mp_limb_t prod_high, prod_low;

j = 0;
cy_limb = 0;
do
{

umul_ppmm (prod_high, prod_low, s1_ptr[j], s2_limb);
prod_low += cy_limb;
cy_limb = (prod_low < cy_limb) + prod_high;
res_ptr[j] = prod_low;

}
while (++j < s1_size);

return cy_limb;

}
© 1996, Free Software Foundation

mpn_addmul_{—}1: In this operation, a 32-bit limb multiplies a multi-bit operand, and the result is added back to the multi-bit operand. The C code implementing this operation is as follows:

mp_limb_t mpn_addmul_1 (res_ptr, s1_ptr, s1_size, s2_limb)
register mp_ptr res_ptr;
register mp_srcptr s1_ptr;
mp_size_t s1_size;
mp_limb_t s2_limb;
{

register mp_size_t j;
register mp_limb_t prod_high, prod_low;
register mp_limb_t x;
mp_limb_t cy_limb;

cy_limb=0;
j = −s1_size;
res_ptr −= j;
s1_ptr −= j;
do

{

umul_ppmm (prod_high, prod_low, s1_ptr[j], s2_limb);
prod_low += cy_limb;
cy_limb = (prod_low < cy_limb) + prod_high;
x = res_ptr[j];
prod_low = x + prod_low;
cy_limb += (prod_low < x);
res_ptr[j] = prod_low;

}

```
  while (++j != 0);
  return cy_limb;
© 1996, Free Software Foundation
```

mpn_submul_{—}1: In this operation, a 32-bit limb multiplies a multi-bit operand, and the multi-bit operand is subtracted from the result. The C code implementing this operation is shown below. The functionality of mpn_submul_{—}1 is similar to the functionality of mpn_addmul_{—}1, allowing for an effective sharing of hardware resources between the custom instructions.

mp_limb_t mpn_submul_1 (res_ptr, s1_ptr, s1_size, s2_limb)

register mp_ptr res_ptr;
register mp_srcptr s1_ptr;
mp_size_t s1_size;
mp_limb_t s2_limb;

{

mp_limb_t cy_limb;
register mp_size_t j;
register mp_limb_t prod_high, prod_low;
register mp_limb_t x;
unsigned i,k,s1_size1,carry;
j = −s1_size;
res_ptr −= j;
s1_ptr −= j;

cy_limb = 0;

do

{

umul_ppmm (prod_high, prod_low, s1_ptr[j],
s2_limb);
prod_low += cy_limb;
cy_limb = (prod_low < cy_limb) + prod_high;
x = res_ptr[j];
prod_low = x − prod_low;
cy_limb += (prod_low > x);
res_ptr[j] = prod_low;

}

while (++j != 0);
return cy_limb;

}
© 1996, Free Software Foundation

Additional custom instructions are also present for performing the operation corresponding to dividing a 64-bit operand by a 32-bit operand and determining the resulting quotient (udivsi3) as well as the modular remainder (modsi3). Custom instructions for loading (storing) the operands from (to) custom registers are also present. The user registers and the corresponding instructions are shared among the different custom instructions added to the processor.

IV.D. Optimizations for the SW Architecture

In this section, we illustrate the different optimizations feasible for the SW architecture of MOSES by using public-key algorithms as an example. We first describe some background material on public-key algorithms for the sake of completeness (for further details, we refer the reader to <4>). We then identify the different parameters in a public-key algorithm, which need to be carefully tuned for efficient execution. Finally, we describe the inter-dependencies between these parameters and the resulting tradeoffs.

1. Public-key Algorithmic Parameters

The most significant factors that control the performance of a public-key algorithm include the size of the input block, the algorithms used for performing modular exponentiation and modular multiplication and the use of special-purpose enhancements like the Chinese Remainder Theorem. In addition, software engineering techniques can also speed up the implementation of an algorithm. We look at a specific optimization (software caches) relevant to this work. Each of these optimizations can lead to several different alternative implementations of the public-key encryption algorithm. Many optimized implementations of public-key algorithms exist, however, to our knowledge, none of them consider all the algorithm optimizations in systematic manner. In order to provide a global view of the space of all possible algorithm configurations, we represent each of the optimizations as an algorithmic parameter. The different parameters controlling the implementation of an algorithm define the algorithm design space. The purpose of our study is to first identify the various algorithm parameters that control the implementation of modular exponentiation. With the algorithm design space defined, we not only want to identify the best value for each parameter (for a particular underlying hardware platform), but also to examine if there is an interplay, among the various parameters, which can be exploited to improve the overall performance of the algorithm.

Each of the optimizations considered in this work is detailed next, following which we comment on inter-dependencies between the various optimizations.

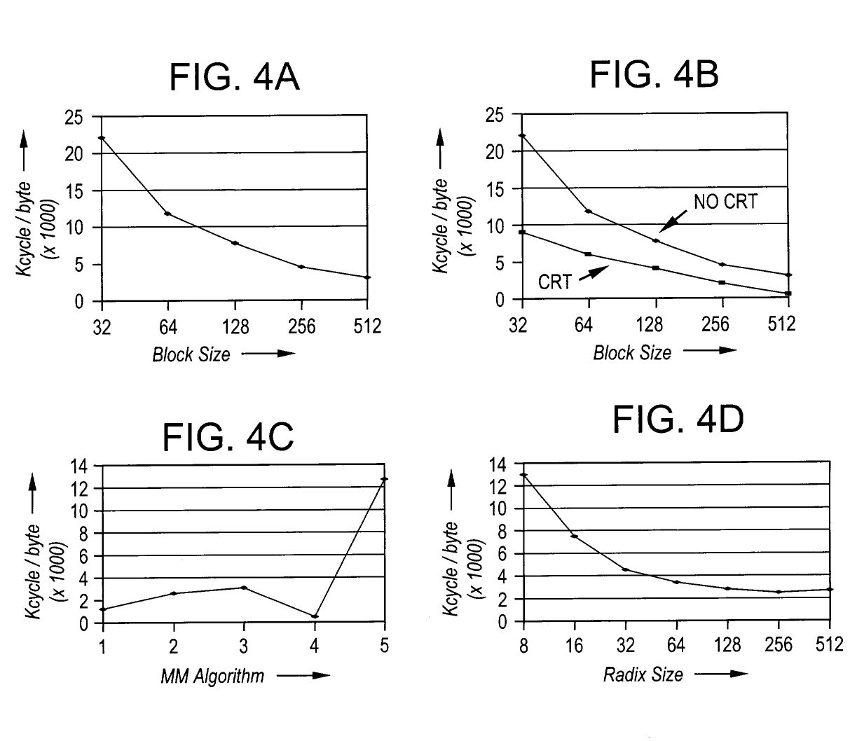

FIG. 4 shows effect of (a) input block size, (b) CRT, (c) MM algorithm, and (d) radix size, as described in subsections below.

2. Input Block Size

A plaintext message is typically divided into several input blocks before encryption. A smaller input block size would reduce the size of the input value to each modular exponentiation step (simplifying its complexity), while increasing the number of calls to modular exponentiation. The effect of input block size on performance, was studied by performing encryption and decryption for varying input block sizes, i.e., 32, 64, 128, 256 and 512 (on the same input). The number of Kilo cycles per byte of input data (Kcycles per byte) consumed for encryption and decryption on an Xtensa™ embedded processor was used to quantify performance. The results, plotted in FIG. 4(a), were obtained by adding the Kcycles consumed by RSA encryption and decryption, for various input block sizes. FIG. 4(a) shows that the greater the block size, the better the performance. But, the performance obtained for block sizes greater than 512 were not significantly greater than that obtained by a block size of 512. Note that the block size cannot be increased beyond the “modulus” (1024-bits in this case) of the public-key algorithm in order to ensure loss-less encryption.

3. Modular Exponentiation (ME) Algorithms

There are two ways of performing modular exponentiation <16>, depending on how the bits in the exponent are scanned, namely: left-to-right (LR) and right-to-left (RL). Suppose that the exponent can be represented in binary form as (e[k−1]e[k−2]. . . , e[0]).In encryption, the cipher text C corresponding to the input block M (or vice-versa for decryption) is obtained as follows:

Left-to-Right (LR) Algorithm: Initially set C=1. For i from (k−1) down to 0. set C=C*C (mod n). In addition, if (e[i]==1), set C=C*M (mod N)

Right-to-Left (RL) Algorithm: Initially set C=1. For i i from 0 up to (k−1), set C=C*M (mod n). In addition, if (e[i]==1), set M=M*M (mod N)

Unlike in the LR algorithm, the operations in an iteration of the RL algorithm are independent of each other. Thus, the RL algorithm can potentially result in a speedup over the LR algorithm. However, the speedup obtained in practice depends on whether sufficient parallelism (e.g., parallel MM units) is available in the target processor.

Chinese Remainder Theorem

The exponent size (of ME) in decryption (usually, 1024 bits) is much larger than in encryption (normally, 16 bits or less). Therefore, decryption is much more computationally intensive and time consuming than encryption. The Chinese remainder theorem (CRT) <17> is employed for reducing decryption times. Using CRT, intermediate values are obtained by performing ME using a reduced exponent size, and these values are combined to obtain the final decrypted result. This is made possible by the knowledge of the secret primes p and q (used to obtain the modulus n). There are two ways of implementing CRT, namely: single-radix conversion (SRC) and mixed-radix conversion (MRC) <16>. We describe the MRC method here. The decryption operation, M=C^{d} mod n, (M, C and d are the plaintext, cipher text and private key respectively) is broken down to M=M1+M3*p, where,

M1=C1^{d1} mod p,

M2=C2^{d2} mod q,

and

M3=(M2−M1)*(1/p mod q)(mod q),

The values d1=d (mod (p−1)) and d2=d(mod(q−1)) are pre-computed for a given private key d. Note that d1 and d2 are half the size of the private key, d, which explains the improvement obtained by CRT. FIG. 4(b) illustrates the superiority of decryption using CRT (lower curve) over decryption without CRT (upper curve).

5. Modular Multiplication (MM) Algorithms

Each modular exponentiation (ME) operation is implemented as a sequence of modular multiplication (MM) operations. Each ME operation involves roughly 1.5 k MM operations, where k is the bit-size of the exponent <18>. For example, when the exponent in ME is 1024 bits, the MM operation is invoked 1500 times, on an average, by each ME operation. Thus, the performance of the MM operation can have a major influence on that of the ME operation (and thereby on the encryption/decryption performance). There are as many ways of performing MM, as there are of performing multiplication and mod operations. Depending on the constituent operations, each MM technique has a varying impact on the performance of the encryption/decryption operations. The main trade-off among the various MM algorithms is between the speed and storage required (to hold intermediate values). In our study, five different MM algorithms were analyzed, whose details are as follows:

Montgomery MM (MM-Algo 1): This algorithm <19> implements the mod operation (reduction of the product) as divisions by a power of 2 . However, there is an overhead incurred in the form of mapping the given inputs to Montgomery residue space before starting the MM computation(preprocessing), and then mapping the result back to the normal space (post-processing).

Radix-r, Separate Montgomery MM (MM-Algo 2): In this variation of Montgomery MM, the reduction of the product is broken into a series of atomic steps, where each atomic step operates on a part (determined by radix r) of the product <20>, i.e., instead of reducing the whole product at once (as in MM-Algo 1), it is broken into chunks (determined by radix r), each of which is successively reduced. The complexity of individual operations in the algorithm is reduced, but the number of operations required increases (compared to MM-Algo 1).

Radix-r, Interleaved Montgomery MM (MM-Algo 3): In this Montgomery MM implementation, the product is accumulated in discrete steps (compared to MM-Algo 2) and successively reduced, and this process proceeds until the entire product is computed (and reduced) <20>. This implementation reduces the storage requirements (because of the partial product accumulation and reduction). The storage and computational complexity of the algorithm are reduced, but the number of steps increases (compared to MM-Algo 1).

Normalization based MM (MM-Algo 4): This algorithm involves obtaining the product using Karatsuba-Ofman method <16>, and then reducing the result using the optimized normalization method <21>. Due to the absence of pre- and post-processing operations, this technique has fewer number of operations than the previous implementations (Algo's 1,2 and 3).

Binary Montgomery MM (MM-Algo 5): This is a special case of MM-Algo 3, where the radix is 2, i.e., r=2_. This particular value of the radix drastically simplifies the operations in Montgomery MM algorithm through the use of very simple and fast bit-wise operations. However, the number of bit-wise operations required is large.

FIG. 4(c) shows the performance of encryption/decryption using the above mentioned MM algorithms in sample ME operations. MM-Algo 5 turns out to be very costly. This can be explained by the large number of bit-wise operations that the algorithm has to perform, together with the poor efficiency of general purpose processors in executing bit-level operations. MM-Algo 4 performs the best.

6. Radix in MM Algorithms

The performance of MM algorithms (MM-Algos 2 and 3) is affected by the choice of the radix. FIG. 4(d) shows the cumulative performance of encryption and decryption using MM-Algo 3 (in ME), as the radix is varied from 8 to 512_. The plot shows that minimum cost is obtained by using a radix of size in MM algorithms. MM-Algo 2 exhibits similar behavior.

7. Caching

Modular exponentiation is a very costly operation and appreciable time savings can be obtained, if the ME operation can be avoided for repeated input blocks (using the previously computed cipher text instead). This observation prompted us to examine the usage of software caches before the ME operation. The encryption process in the presence of caches can be described as: if (M[i] present in cache) then use C[i] from the cache, else C[i]=M[i]^{e} mod N. Decryption can be implemented in the same way. This kind of cache is referred to as the pre-ME cache.

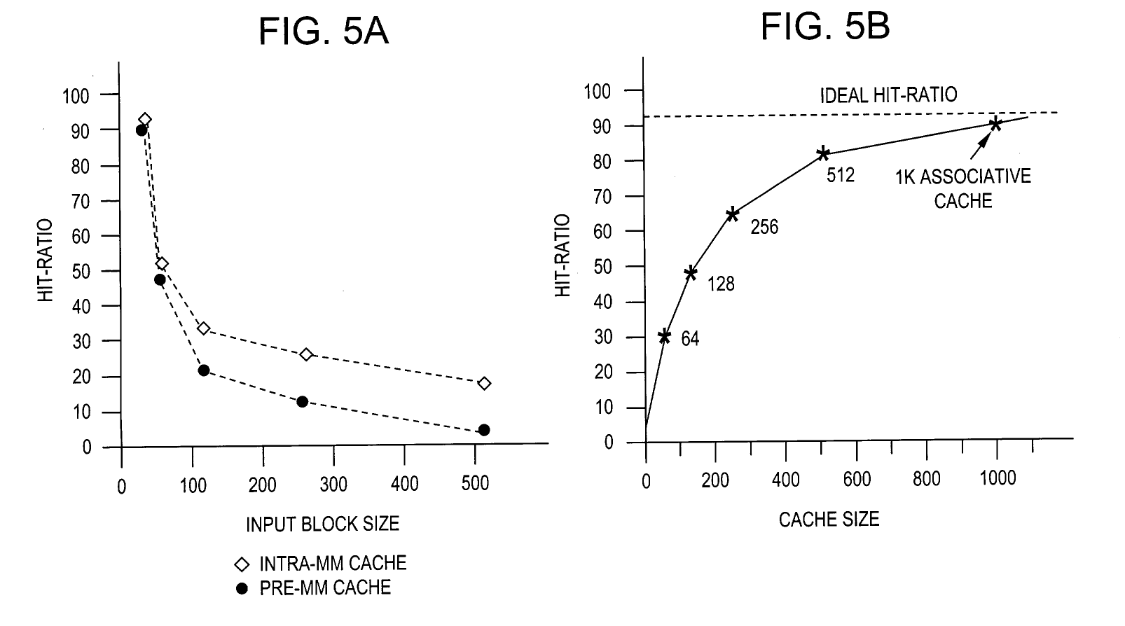

FIG. 5 shows effects of caching (pre-ME and intra-MM). As mentioned earlier, a typical 1024-bit exponent ME operation results in 1500 MM operations on average. This increases the chances of inputs, to the costly multiplication and mod operations in the MM operation, being repeated. This motivates the use of software caches inside the MM units. Although, multiply and mod operations are not as costly as the ME operation, appreciable savings can still be obtained for a moderate hit-ratio. For example, MM-Algo1 has a step M=T.N (mod R), in which N and R are fixed for the entire duration of encryption (or decryption). We use a cache in the following manner: if (T is present in the cache) then assign the corresponding computed value from the cache to M, else compute M=T.N (mod R). This type of cache is called intra-MM cache.

FIG. 5(a) shows the variation in the hit ratios of pre-ME (lower curve) and intra-MM (upper curve) caches as a function of the input block size. Intra-MM caches exhibit better performance scaling compared to pre-ME caches, as the input block size is increased. For this experiment, we assumed unlimited cache sizes, i.e., the modular exponentiation result computed on each unique input block is added to the cache. Due to the overheads associated with maintaining a software cache, in practice, it is necessary to limit the cache size and consequently use a replacement policy.

In order to evaluate the cache size necessary for a good hit ratio, we performed experiments with associative cache sizes of varying sizes. The results indicate that a 1K cache results in a hit-ratio almost equal to the “ideal” hit-ratio (FIG. 5(a)) for pre-ME caches (FIG. 5(b)). The same behavior is observed for intra-MM caches also. Thus, 1K associative caches were used for pre-ME and intra-MM caches.

8. Inter-dependences and Trade-offs

The different combinations of the parameters seen above result in a very large design space. Such a design space needs to be explored completely in order to determine the optimal choice of parameter values. This is necessary because the best-performing value for one parameter may not appear in the overall best configuration (with other parameters included) for the public-key algorithm. For example, FIG. 4(a) indicates that the input block size of 512 bits is potentially a good choice for public-key encryption/decryption. With this block-size (along with 1024-bit RSA modulus and “algo 1”), the cost of encrypting an example wireless data transaction is 64301.07 Kcycles on the target processor. On the other hand, the cost of encrypting the same transaction with a 32-bit input block size and a pre-ME cache reduces to 15714.5 Kcycles, which reflects a performance improvement of 75.5% with respect to the 512-bit input block size (after accounting for the overhead introduced by the cache). The above experiment demonstrates that performing each algorithmic optimization separately (independently) can lead to significantly sub-optimal performance. Exploring the large design space to determine the optimal configuration of parameters, therefore, becomes inevitable. We have developed an efficient algorithmic design space exploration strategy to address this need, which we describe later.

IV.E. Optimized Architecture for a System Containing MOSES

In this section, we describe how MOSES can be integrated into a host system (e.g., a wireless phone, PDA, etc.) as a security processor, to render the system capable of efficient security protocol processing. These benefits effectively result in enabling advanced secure applications, higher application-level performance, and a better overall user experience. An optimized system-level architecture enables the best utilization of MOSES' security processing capabilities. Further, the system architecture needs to designed to minimize or eliminate the risk of malicious or buggy software running on the host CPU (or any other system component) compromising the security of sensitive information that is contained in the system.

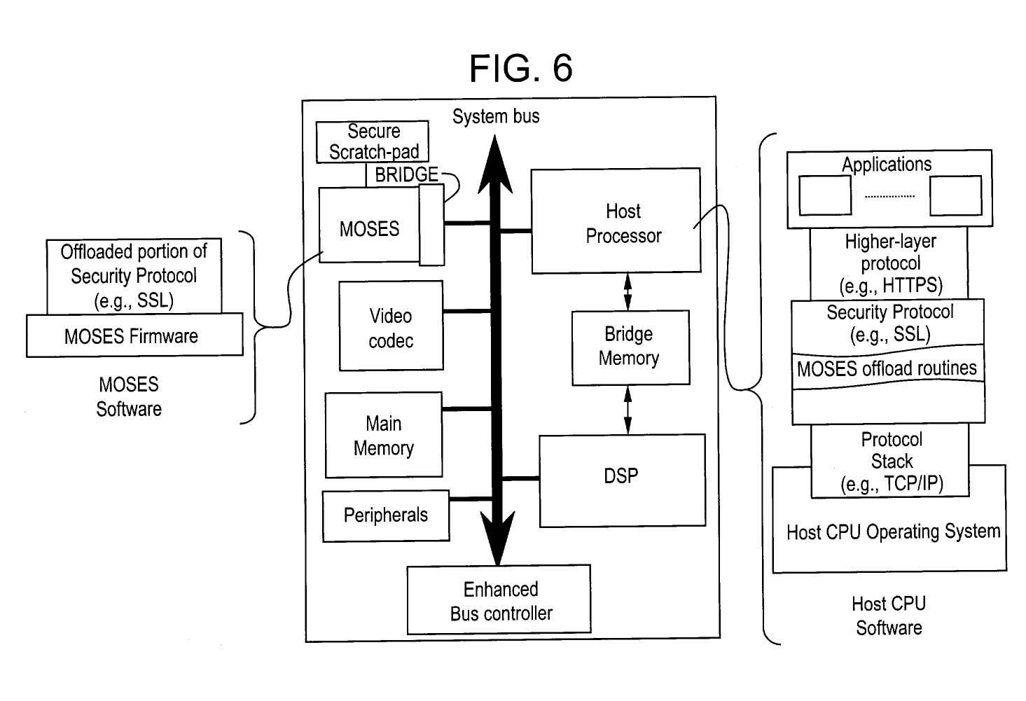

FIG. 6 shows an example of a system that includes a host processor and MOSES as a security processor (many alternative architectures, including direct connection of MOSES and the host CPU, may be possible). The figure indicates the hardware integration of MOSES into the system, as well as the relevant software that runs on the host processor and MOSES. From a hardware perspective, MOSES is connected to the host system bus through a bridge. If MOSES is required to access the system main memory independent of the host processor, the bridge should include the capability to act as a master on the system bus. Further, the bridge may feature Direct Memory Access (DMA) and other burst transfer capabilities to minimize memory access overheads and allow for a greater degree of parallel operation between MOSES and the host processor. A dedicated memory, called a “secure scratchpad” in FIG. 6, may be connected to MOSES. This memory can be directly accessed only by MOSES, and may be used for storing sensitive information, such as keys, passwords, etc., as well as for storing intermediate results generated during the execution of MOSES. In addition to the secure scratchpad, it is also possible to denote a portion of the system main memory as a secure segment, to which access is restricted to a limited set of system components and/or software functions running on the host processor or MOSES. Such access policies are enforced through the use of an enhanced bus controller. The enhanced bus controller observes each bus transaction, and determines whether it legal, i.e., complies with the defined access policy. If the bus transaction is determined to be illegal, the enhanced bus controller may either reject the bus access request, or signal an error or exception to abort the transaction.

The software running on the host processor and MOSES are also indicated in FIG. 6. The software executing on the host processor includes a security protocol that contains routines offloading part of the security protocol to MOSES. In addition, the host processor may execute an operating system (OS), network protocol stacks (e.g., TCP/IP), and one or more applications.

It is important to note that, since MOSES includes a programmable processor, there is great flexibility in determining with portions of the security protocol are offloaded to MOSES. This feature may be exploited to result in the following benefits:

Portions of the security protocol other than the core cryptographic algorithms to MOSES. It may often be necessary to offload such functionality (e.g., packet processing functions such as byte re-ordering or packet header parsing) in order to truly optimize application-level performance (or energy efficiency).

The partitioning (or allocation) of functionality between the host processor and MOSES can be determined to minimize the communication requirements between them.

Multiple allocations of the security protocol functionality may be derived. The choice of allocations, as well as the choice of when to use each allocation, may be performed statically or dynamically (during system execution), based on various factors, including the application's data rate and security requirements, host processor workload, MOSES workload, and system bus workload.

It may be often necessary for a system containing MOSES to execute multiple concurrent applications. In such scenarios, more then one application may require to utilize MOSES for efficient execution of security protocols. The hardware architecture of MOSES, as well as the software it executes, can be optimized to provide further efficiency in the processing of multiple secure data streams. Such optimizations can include techniques for low overhead multiplexing (or interleaving) of computations corresponding to different data streams. Further, the amount of data that has to be transferred to/from MOSES when switching to a different security stream can be minimized by storing some of this context information in the dedicated memory that is connected to MOSES. The context information for each stream includes a stream identifier, protocol state (e.g., session context and key information), and cryptographic algorithm state (e.g., the feedback vector for ciphers that are employed in output feedback mode). In addition, the allocation of security protocol functionality between MOSES and the host processor may be determined independently for each stream based on its unique requirements.

IV.F. Design Methodologies

In this section, we present methodologies used for designing a wireless security processing platform. We first present an overview of the entire methodology. Subsequently, we detail the selection of the software constituents of the platform, followed by a description of the steps involved in customizing the hardware platform.

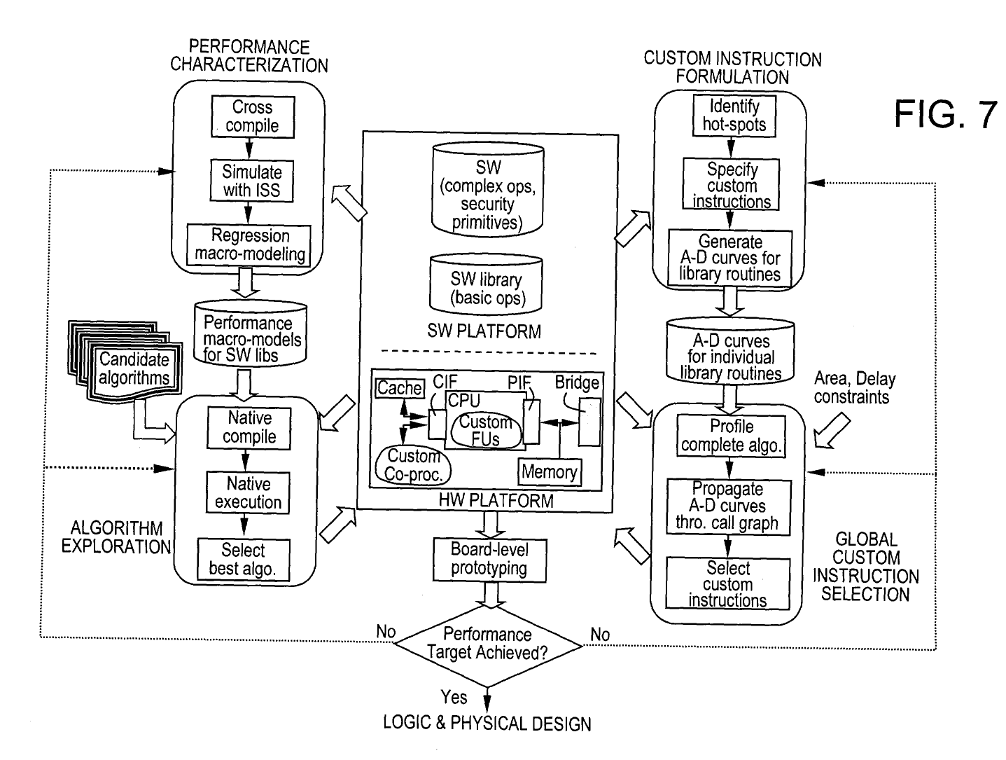

FIG. 7 shows an overview of the security processing system design methodology.

1. Overview

FIG. 7 outlines system-level design steps that were used during the design of MOSES.

There are four major phases in the flow: (i) performance characterization of software libraries, (ii) algorithm exploration, (iii) formulation of candidate custom instructions to accelerate individual library routines, and (iv) global custom instruction selection to generate the required performance for each security algorithm. The methodology exploits the layered SW architecture in order to separate the above steps in a clean manner. Specifically, only implementations of the lower SW layers (standard libraries, basic operations) are required for performance characterization and formulation of custom instruction candidates, while algorithm exploration and global custom instruction selection are performed using the higher SW layers (complex operations, security primitives) while regarding the lower SW layers as a black box.

We now briefly describe the salient steps of our methodology, details of which are found in later explanations.

The simulation time required for performance estimation is a significant bottleneck in algorithm design space exploration (in our context, several hours to few days per candidate algorithm). The performance macro-modeling phase effectively addresses this problem by enabling performance estimation through native compilation and execution, which can be orders of magnitude faster than Instruction Set Simulation. During the performance macro-modeling phase, we characterize the software library routines that constitute the basic steps of the algorithm, using a cycle-accurate ISS. We use statistical regression techniques to build macro-models that express the execution time of each routine as a function of parameters characterizing its input variables. The performance macro- modeling phase is explained in further detail later in this section.

The algorithm exploration phase attempts to identify optimal algorithmic implementations of security processing algorithms such as RSA, AES, 3DES etc. For each algorithm candidate, we instantiate the performance macro-models for library routines in the source code, and replace ISS runs with native compilation and direct execution on a host workstation, resulting in large speedups in simulation time. In our context, that allows exhaustive exploration of the algorithmic design space to be performed.

In most scenarios, the optimized algorithm running on the base hardware platform does not achieve the target performance. Therefore, it becomes necessary to customize the underlying HW architecture, through custom instruction extensions in our case. During the custom instruction formulation phase, we focus on speeding up individual software library routines. That allows our designers to focus on small problem instances, where they best apply their creativity, leaving the global tradeoffs to the subsequent phase. The routine under consideration is profiled using traces derived from simulation of the entire algorithm. The computation-intensive parts of the routine are specified as a custom instruction. The hardware resources (functional units, register files, lookup tables, etc.) used in the custom instruction are varied to create a local area vs. delay tradeoff for the individual library routine. Having a rich set of alternatives is critical to achieving a high-quality solution in the global custom instruction selection phase. The custom instruction formulation phase is discussed further later in this section.

The global custom instruction selection phase determines a combination of (possibly several) custom instructions to result in maximum speedup for the entire security algorithm subject to any applicable area constraints. This phase proceeds by propagating A-D curves for library routines through the function call graph of the entire algorithm. The potential explosion in the number of instruction combinations is contained using several techniques. The global custom instruction selection phase is described in detail later in this section.

2. Performance Macro-modeling for Algorithm-level Design Space Exploration

In this section, we present an overview of the proposed methodology for evaluating algorithmic trade-offs in wireless security processing. _Note that, the proposed flow is general enough to be applied for exploring the algorithmic design space of other embedded software applications.

Most algorithms, including security algorithms, are designed as high-level entities that invoke functions from one or more pre-existing software libraries. Such an approach is used in design of our security processing platform, wherein the security algorithm sits atop a layer of software libraries, which in turn sit above the actual target architecture. As seen from earlier sections, there are many algorithmic choices or combinations of optimizations that must be examined so as to arrive at the best possible software implementation. The best choice is the one that requires the least number of CPU cycles, on an average.

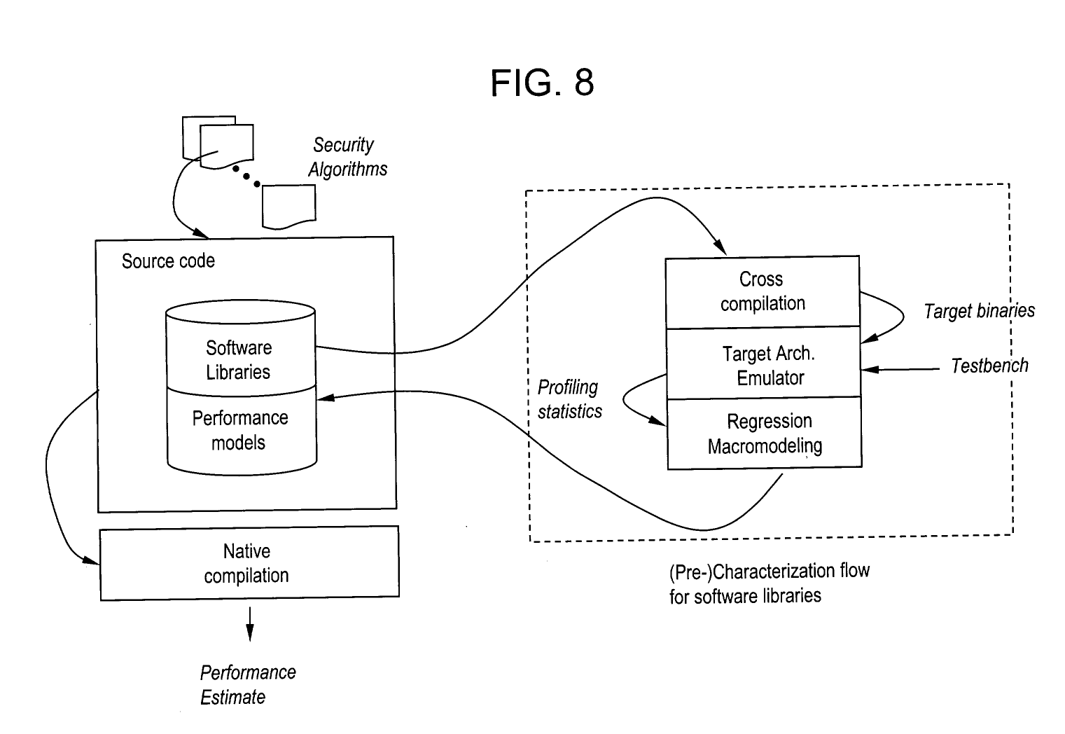

FIG. 8 shows enhanced architectural simulation with pre-characterized software libraries. Traditional methods of performing this evaluation would require running each candidate algorithm (serially, or, in parallel) on a target architecture ISS to derive performance metrics. Since each simulator run is slow and computationally expensive, we propose an alternative evaluation flow as shown in FIG. 8. In this flow, we migrate the simulation runs to the native architecture and estimate the performance of an algorithm on the target architecture. Such a flow uses models of the software library routines that replicate (to a high degree of accuracy) their performance characteristics on the target architecture.

A performance model is a function that parameterizes the number of cycles incurred by the actual run of a library routine with some input data in terms of variables that characterize the input data. This characterization is performed by regression macro-modeling (as shown in FIG. 8) that takes as its input, (a) performance data of the library routine on the target for different input samples, and, (b) data values for the variables characterizing those input samples.

The performance data is collected from the profiling statistics generated by simulation runs on test programs containing the library routines for different input stimuli. This is a one-time cost, thereby accelerating the overall simulation process. Since the input space for a library routine can potentially be infinite, test bench generation is application-driven in the sense that the input samples are generated for the input space used by the application. For example, the GNU MP library provides a wide variety of C functions that can perform arbitrary precision arithmetic on integers, rational numbers and floating point numbers. However, a 1024-bit RSA algorithm requires only a few of those arithmetic functions with the operations restricted to (less than or equal to) 1024-bit arithmetic. Therefore, we characterize the library routines for this restricted domain only.

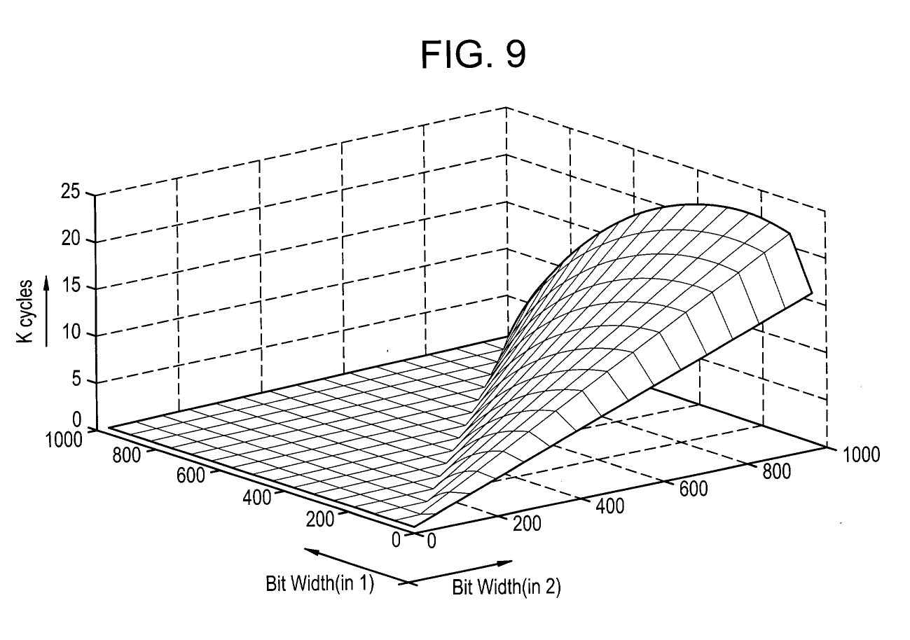

FIG. 9 depicts a performance profile of function mod(in2,in1) over different input bit-widths. The performance profiles of arithmetic functions show a regular behavior (piecewise linear, quadratic, etc.) over input bit-width subspaces. For example, the average performance of function mod for different input bit-widths (the Cartesian product of BW1: (32, 96 . . . 992)×BW2: (32, 96 . . . , 992) on a specific Xtensa□ processor configuration is shown in FIG. 9. The plot indicates that a single function

cannot fit the profile in an accurate manner. Therefore, the profile is partitioned along the lines (bw1<bw2), ((bw1>=bw2)&&(bw2>32)) and ((bw1>=bw2)&&(bw2<=32)). The corresponding fits obtained using S-PLUS <22> are indicated below.

cost=0.06990126+0.0005330226*bw1−2.62605e-06*bw2

cost=0.3416738+3.998125e-5*bw1*bw2−1.450325e-6*bw1*bw2−3.844676e-5*bw2*bw2+0.02121358*bw1−0.02028056*bw2

cost=0.5812022+0.000106492*bw1*bw2+0.01292429*bw1−0.02093991*bw2

The mean absolute errors of this model are very small (0.01853528, 0.01337336 and 0.128225 for the three fits). To understand the accuracy of this fit, we can compare the performance estimate for an input sample not used in the regression macro-modeling process with the measured value. For example, the performance estimate for (BW1=1024, BW2=1024) is 1.385 Kcycles, while an actual simulation run with 500 uniform random values averages to 1.35 Kcycles.

In this way, the performance model for a library routine can be derived fairly easily and accuratelyusing regression based approaches. All library routines instantiated in the source code of an algorithm can now be augmented with their respective performance models to estimate the overall performance of the algorithm on the target architecture, while running solely through native execution.

3. Formulating Custom Instruction Candidates and A-D Curves

FIG. 3 shows the profile statistics of an optimized modular exponentiation algorithm as a function call graph, with nodes representing function names, and edges weighted by the number of calls made to each function. For example, the function decrypt makes 4, 4, 2, 2 and 2 calls, to functions mpz_mul, modPow, mpz_mod, mpz_add and mpz_sub, respectively. Each node in the call graph may have more than one parent, since a function may be invoked by multiple higher-level functions. For example,

mpz_mul is called by three functions decrypt, modMul and mpz_gcdext. For the sake of simplicity, the call graph in FIG. 3 is truncated at functions that are highlighted with bold text, i.e., calls to lower-level functions are not shown. The leaf nodes of the call graph in FIG. 3 correspond to the library routines for which custom instructions are added in an interactive manner with the designer's involvement. It bears mentioning that, the granularity of the leaf nodes is a critical choice that determines the effectiveness of the custom instructions. Ideally, a function chosen to be a leaf node should contain sufficient amount of computation so as to provide scope for optimization, while being small enough that it is easy for a designer to understand and optimize. Our methodology contains heuristics for the choice of the leaf node based on the function's size and the fraction of the total program execution time it accounts for. However, we also provide the designer with an option to override automatic choices and manually specify the leaf nodes.

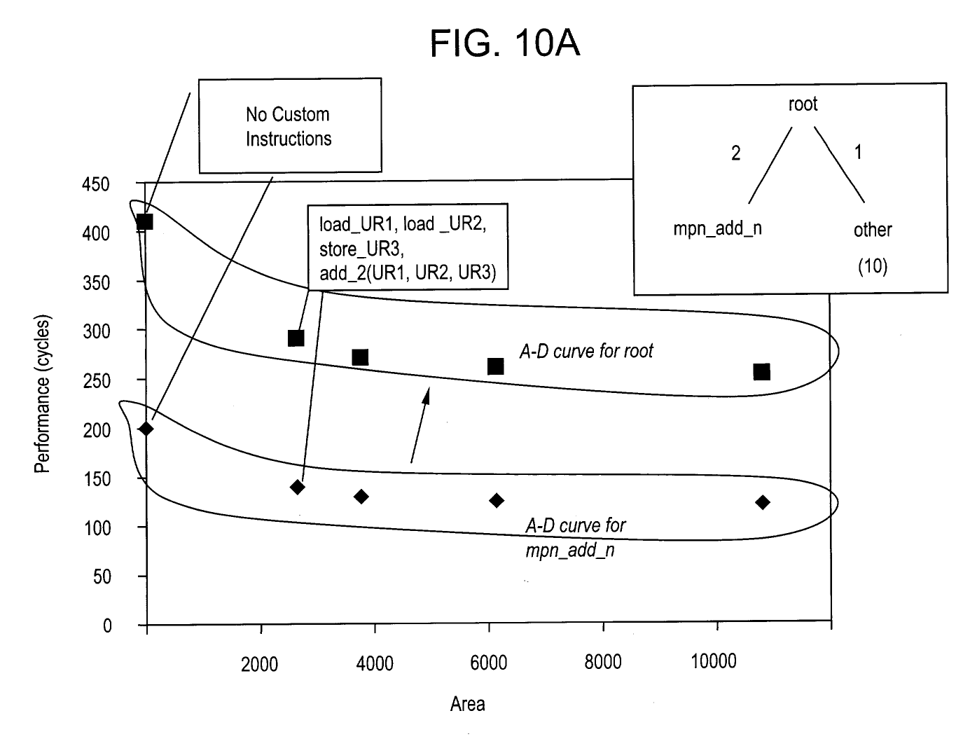

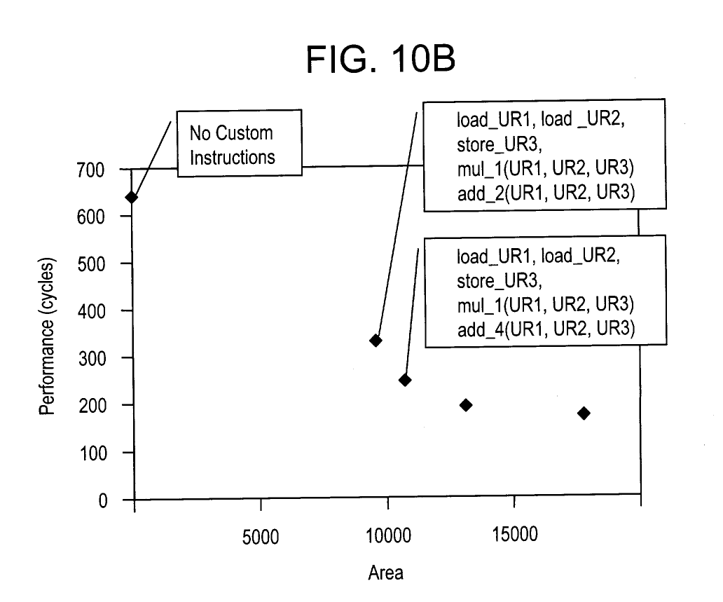

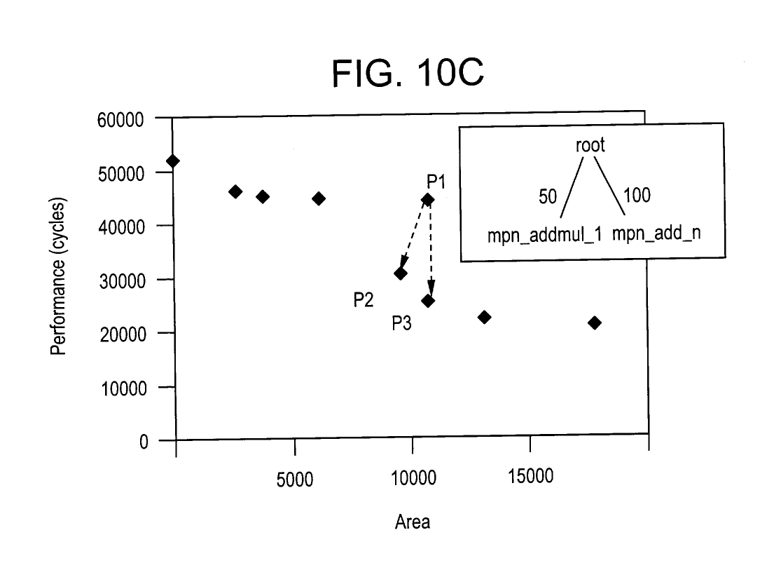

Since the added custom instructions can be provided with a variable number of hardware resources, we can associate an area-performance trade-off curve (also called A-D curve) with each custom instruction. The lower-most set of points in FIG. 10(a) shows the A-D curve for a sample library routine mpn_add_n that performs the addition of two vectors. The original library routine is represented by the design point that has a zero area overhead and a performance of 202 cycles, as shown. All other design points are derived through custom instruction additions with varying number of adder resources, and hence, have non-zero area overheads. For example, the second design point is achieved by adding custom load/store instructions load_UR1, load_UR2 and store_UR3, and an addition instruction add_{—}2 that uses two 32-bit adder resources. When the number of adders is changed to 4 (add_{—}4_), performance improves at increased area costs, creating the next design point in the A-D curve. At some point, additional resources bring diminishing returns (e.g., due to limits on parallelism or memory bottlenecks).

4. Global Custom Instruction Selection

In this section, we describe our methodology for selecting custom instructions using A-D curves of software library routines and the annotated call graph of the entire algorithm. Our procedure for selecting custom instructions involves combining and justifying A-D curves in a bottom-up fashion to derive a composite A-D curve for the root node of the call graph. The area and performance constraints for the platform can then be applied at the root node to pick the final custom instruction(s).

For any subgraph rooted at a node f, with children given by the set children(f)f, the performance of f f is governed by the following equation

cycles(f)=local_cycles(f)+Σ_{g} cycles(g);

where, g ε children(f)

In the above equation, local_cycles(f) refers to the number of cycles spent in computations local to f, which do not involve calls to any of its children. The above equation can be directly applied when all members of the set children(f) have a single performance number associated with them (i.e., no A-D curves). However, when A-D curves of one or more functions in children(f) need to be combined, there are a few issues involved, as illustrated below. When the root node of a sub-graph in the call graph has multiple children, the A-D curve computation simply degenerates to repeated application of the following cases.

FIGS. 10(a)-(c) show different types of A-D curves. Two child nodes—one child with an A-D curve and another with no A-D curve: FIG. 10(a) illustrates this case for the graph rooted at node root, with one child mpn_add_n (which has an A-D curve), and a second child other (which requires 10 cycles per call). In this case, for every design point in the A-D curve of root, we have a corresponding design point in the A-D curve of mpn_add_n, with the performance computed using Equation (4).

Two child nodes with A-D curves: FIG. 10(c) illustrates this case using a graph rooted at node root with two children, mpn_add_n and mpn_addmul_{—}1, whose A-D curves are shown in FIGS. 10(a) and 10(b), respectively. As in the previous case, the performance of root is the sum of the performances of its children, each weighted by the number of calls made to them. In general, every combination of design points (Cartesian product) from the A-D curves of mpn_add_n n and mpn_addmul_{—}1 must be represented as a distinct point in the A-D curve of root. However, it turns out that whenever instructions are shared or dominated between design points, the number of design points in the composite A-D curve can be significantly reduced, as explained next.

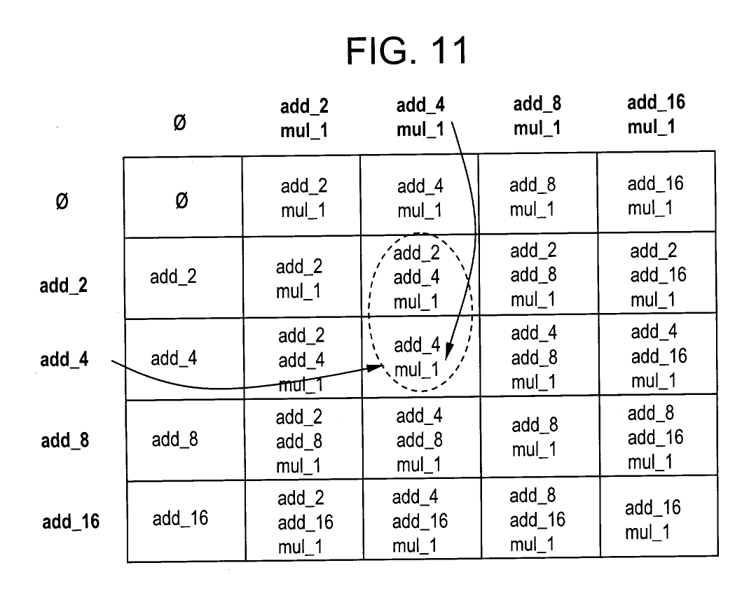

FIG. 11 shows the Cartesian product of the points on the A-D curves for mpn_add_n n and mpn_addmul_{—}1. Each entry corresponds to the union of the custom instructions that constitute the individual design points (we ignore load/store instructions, which are shared across both the children). For example, the shaded entry add_{—}2, mul_{—}1 is the union of custom instructions add_{—}2, mul_{—}1 for function mpn_addmul_{—}1, and add_{—}2 d for function mpn_add_nn. The symbol ø is used to denote the null set, i.e., no custom instructions. Observe that the shaded entry add_{—}2, add_{—}4, mul_{—}1 in FIG. 11 is equivalent with many other design points. This is possible (i) when entries have the same custom instructions or (ii) when entries reduce to the same custom instructions. For example, the entry add_{—}2, add_{—}4, mul_{—}1 has two add instructions add_{—}2 and add_{—}4, which differ only in the number of adder resources available while realizing the same functional capabilities. Given that add_{—}4_ can be used to perform add_{—}2 with equal or better performance, we say that add_{—}4 dominates add_{—}2dd, and reduce add_{—}2, add_{—}4, mul_{—}1 to add_{—}4, mul_{—}1. FIG. 11 contains 25 candidate design points, which can be reduced to only 9 points corresponding to the shaded entries in FIG. 11. The reduced set of 9 points are represented in the A-D curve for rootot, as shown in FIG. 11(c).

FIG. 11 depicts combining the design spaces of two area-delay (A-D) curves. Note that, at the root node of the entire call graph, the standard notion of Pareto-optimality can be applied to eliminate inferior points. In FIG. 10(c), we can prune away design point P1, which has inferior performance while incurring more area with respect to design points P2 and P3.

IV.G. Experimental Results

The security processing platform MOSES was designed and evaluated in the context of popular network-layer and transport-layer security protocols (e.g., IPSec, SSL, WTLS, etc.). We first describe the experimental methodology used to evaluate MOSES. We then illustrate the performance of MOSES in speeding up the secure socket layer (SSL) protocol and its constituents, as well as its performance as a security co-processor for a handheld device. We also discuss the results of the algorithmic design space exploration methodology, as well as the efficiency and accuracy of the macro-modeling based performance estimation technique.

1. Experimental Methodology

For algorithmic design space exploration, each algorithm candidate was implemented as a highly modular, optimized C implementation using library routines from two well-known software libraries: (i) The GNU MP library <21> provides a wide variety of functions that can perform arbitrary precision arithmetic on integers, rational numbers and floating point numbers, and (ii) a hash library that provides a reliable means for creating hash tables. The GNU based cross-compiler, and the instruction set simulator for the target processor (an Xtensa™ processor core from Tensilica Inc. <14>, running at 188 MHz in 0.18 micron technology) were used to profile the different library routines. Performance macro-models were constructed using the statistical modeling tool S-Plus <22>. Native simulation was then performed on a SUN Ultra 10 440 MHz workstation with 1 GB of memory to select the best algorithm configuration for the given target hardware.

The different custom instructions were implemented as Tensilica Instruction Extension (TIE™) descriptions and parameterized for generating A-D curves. The TIE™ descriptions were compiled using the TIE™ compiler <14>, which generates both C-stubs and synthesizable RTL Verilog descriptions. The C-stubs were then instantiated as intrinsics in test programs to derive the performance numbers in the A-D curves. The RTL descriptions of any custom hardware additions were subject to logic synthesis using Synopsys Design Compiler™ <23> and technology mapped to the NEC CB-11 0.18 micron technology library <24> to determine the area numbers. The global instruction selection procedure described earlier was then used to evaluate the different TIE™ candidates. The TIE™ solutions determined were combined with the base Xtensa™ processor core using the Xtensa™ processor generator <14> to build the enhanced target hardware.

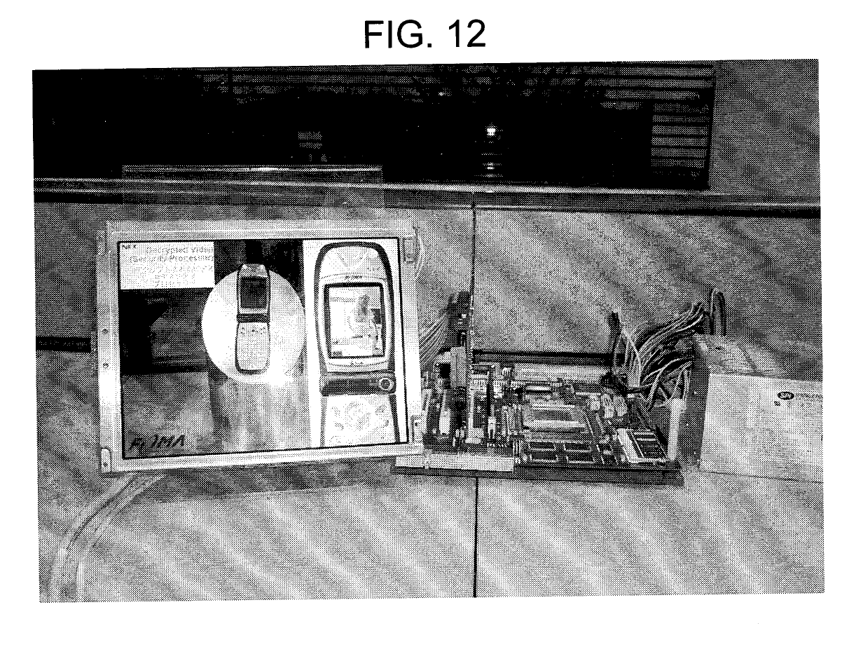

FIG. 12 shows an example functional prototype of the security processing platform.

2. Evaluation of MOSES

We evaluated the performance of our security processor platform using standard implementations of private-key algorithms such as DES, 3DES, and AES, as well as the public-key algorithm RSA. The optimized HW platform and SW implementation resulting from our system design methodology were used to build a board-level prototype implementation of the security processing platform, which is shown in FIG. 12. The prototype was built using the XT-2000™ emulation board <25> with an EPSON graphics controller card <26> interfacing with an NEC LCD panel <27>. The system prototype was used to demonstrate security processing performance improvements under various application scenarios, including real-time video decryption and SSL transaction acceleration.

TABLE 1
Performance speed-ups for popular security
processing algorithms

Processing Rates

| | Orig. | Final | |
|---|---|---|---|
| Sec. Algo. | (cycle/byte) | (cycle/byte) | Speedup |
| DES enc./dec. | 476.8 | 15.4 | 31.0X |
| 3DES enc./dec. | 1426.4 | 42.1 | 33.9X |
| AES enc./dec. | 1526.2 | 87.5 | 17.4X |
| RSA enc. | 34.29E3 | 3.16E3 | 10.8X |
| RSA dec. | 12658E3 | 190.78E3 | 66.4X |

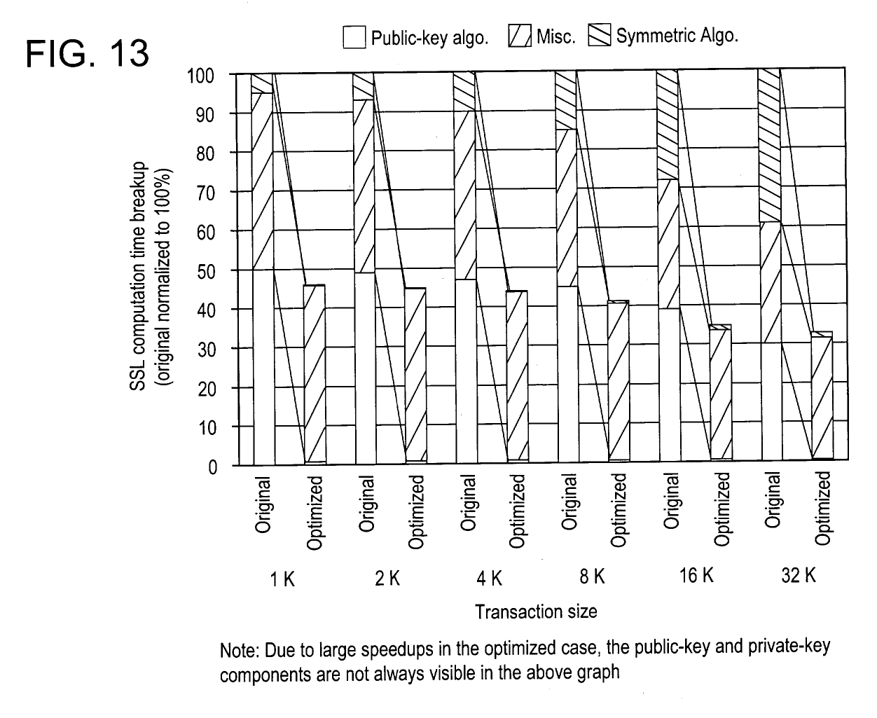

Table 1 illustrates the performance speed-ups for the individual security processing algorithms: 31.0× for DES, 33.9× for 3DES, 17.4× for AES, and upto 66.4× for RSA. Note that, these improvements are obtained compared to already optimized software implementations. We next see how the enhancements made to these security algorithms help in speeding up the popularly used transport layer security protocol, SSL <5>. SSL uses a combination of private-key and public-key algorithms to secure the data transferred between a client and a server. The SSL handshake first allows the server and client to authenticate each other, using public-key techniques such as RSA. Then, it allows the server to create symmetric keys, which are exchanged and used for rapid encryption and decryption of bulk data transferred during the session. FIG. 13 shows the estimated speedup of SSL transactions through the use of our security processing platform. The breakup of the computation workload for SSL processing between the private-key algorithm, public-key algorithm, and other miscellaneous computations, is also indicated in FIG. 13.

FIG. 13 shows estimated speedups for SSL transactions. Note that, the breakup depends on the session size, hence we considered various session sizes ranging from 1 KB to 32 KB. For small data transactions (where public-key algorithm computations in the SSL handshake dominate), MOSES contributes to an overall transaction speedup of around 2.18×. In the case of large transactions, (where the private-key algorithm starts to dominate the overall computation) MOSES achieves an overall transaction speedup of 3.05×.

MOSES was also used as a co-processor in a handheld device to accelerate security-specific computations. Functioning as a co-processor to an IPAQ 3870 PDA playing a 10 Mbyte secure real-time video, MOSES facilitates a 9× reduction in connection setup latency and a 32× improvement in effective data rate.

3. Algorithm Design Space Exploration

In this section, we examine in detail how an optimum configuration in the public-key algorithm design space for use in a popular handshake protocol (SSL) was determined. We describe the SSL handshake protocol and its public-key components, and present the results of our experiments, including the optimal algorithm identified therein. Efficiency and accuracy results for design space exploration are subsequently reported.

TABLE 2
SSL handshake protocol: Characteristics of
public-key functions used

| Parameter | Stage 1 | Stage 2 | Stage 3 |
|---|---|---|---|
| Data Size | 1024 bits | 288 bits | 384 bits |
| Key Size | 16 bits | 1024 bits | 16 bits |

a) Public-Key Computations in SSL Handshake

The SSL handshake constitutes the initialization part of the SSL protocol. It is primarily used to securely exchange the key (used subsequently for secure bulk data transfers) between the client and the server, and is dominated by public-key algorithm computations. The client is required to perform public-key operations at three stages of the SSL handshake protocol, which are:

Stage 1: To verify the digital signature of the certificate authority (CA) who has signed the server certificate. This involves decryption using the public key of the CA.

Stage 2: To prepare its (client) digital signature. This is achieved by encrypting a piece of data using the private key of the client.

Stage 3: Encrypting the pre-master secret using the public key of the server. The “pre-master secret” is used both by the client and the server to derive the session key.

The sizes of the data handled (encrypted or decrypted) in each stage and corresponding key sizes are given in Table 2.

TABLE 3
Optimal stage-wise parameter values and
speedups for the SSL handshake protocol

| Parameter | Stage 1 | Stage 2 | Stage 3 |
|---|---|---|---|
| Input Block Size | 512 | 512 | 512 |
| Radix | 256 | 256 | 256 |
| MM Algorithm | Algo 4 | Algo 4 | Algo 4 |
| CRT | SRC | MRC | SRC |
| Pre-ME Cache | No | No | No |
| Intra-MM Cache | Yes | No | Yes |
| Speedup | 74.6% | 82.9% | 66.37% |

b) SSL Handshake Protocol: Optimal Algorithm Choice

In order to determine the optimal public-key algorithm choice for SSL Handshake, over 450 algorithm candidates must be evaluated due to the permutations arising from two ME algorithms, five MM algorithms, five input block sizes, three CRT implementations (two distinct implementations, in addition to the absence of CRT), and three cache options (no cache, only pre-ME cache and only intra-MM cache). Simulating a single transaction of the SSL handshake protocol over a space of over 450 RSA algorithm configurations requires nearly 38 days of CPU time. In order to identify the optimum algorithm configuration, we used the software performance estimation methodology based on automatic characterization and macro-modeling of the software library routines.

Table 3 summarizes the results of design space exploration with the algorithm parameter values determined for optimal performance of the three public-key stages in the SSL Handshake protocol. The presence of CRT introduced a significant performance gain in Stage 2, and to a lesser degree in Stages 1 and 3. But, single-radix conversion (SRC) implementation of CRT results in better performance in Stages 1 and 3, while mixed-radix conversion method of implementing CRT performs better in Stage 2. The presence of Pre-ME cache did not contribute to a performance gain in any of the stages, while the Intra-MM cache resulted in modest gains only in Stages 1 and 3. MM-Algo 4 resulted in the best performing RSA encryption and decryption, in all the stages. Likewise, an input block size of 512 bits resulted in optimal performance across all the stages. The radix value applies to MM-Algo 2, which was observed to be the next best performing MM algorithm. The radix value of 256 considerably improved the performance of MM-Algo 2 over the conventional Montgomery implementations (MM-Algo 1). The last row in the table indicates the overall performance gain of the optimal algorithmic configuration indicated for each stage over the conventional choice (that uses Montgomery MM algorithm, with 128 bit input block sizes <5>, and radix size of 32 <20>)

Table 4 illustrates the performance impact of replacing a single design parameter in a conventional public-key algorithmic configuration with its corresponding optimal value (Table 3). We can see that by making only the input block size optimal (i.e., 512 bits), performance improves by 70.5%, 63.1% and 62.08% in Stages 1,2 and 3, respectively. The presence of CRT improves the performance of Stage 2 by 63% (using MRC method), and by 32% and 30.2% in Stages 1 and 3 (by using SRC method). The presence of the Intra-MM cache enhances the performance of Stages 1 and 3 only.

From Table 3, we also note that a particular set of values result in optimal performance in Stages 1 and 3, while a different set of values yield the best performance in Stage 2 (especially with respect to using the Intra-MM cache and the CRT algorithm).

Table 4: Effect of optimal parameter values on performance:

TABLE 4
Effect of optimal parameter values on performance

| Parameter | Stage 1 | Stage 2 | Stage 3 |
|---|---|---|---|
| Input Block Size | 70.5% | 63.1% | 62.1% |
| Radix | 10.6% | 11.8% | 10.5% |
| MM Algorithm | 43.7% | 43.2% | 45.2% |
| CRT | 32.0% | 63.0% | 30.2% |
| Pre-ME Cache | — | — | — |
| Intra-MM Cache | 5.1% | — | 4.6% |

Table 5 gives the cost of a SSL handshake session on a wireless client using the conventional configuration, only the optimal configuration determined for Stage 1 for all the three stages (fixed solution) and the optimal configuration for each stage (adaptive). SSL handshake incorporating optimal parameter assignment (fixed and adaptive) demonstrates nearly a 5× speedup over SSL handshake using the conventional public-key parameters. We can also see that while the difference in performances from using the adaptive and fixed solutions is not large, the adaptive solution comes at practically no extra cost. This observation justifies the use of the adaptive solution for effective execution of public-key operations in the SSL handshake protocol.

TABLE 5
Performance of conventional, fixed and adaptive
public-key solutions to SSL Handshake Protocol

| Parameter Assignment | Total Cost (Kilo Cycles) |
|---|---|
| Conventional | 562115.54 |
| Fixed | 98968.86 |
| Adaptive | 98744.42 |

c) Efficiency and Accuracy of the Proposed Methodology

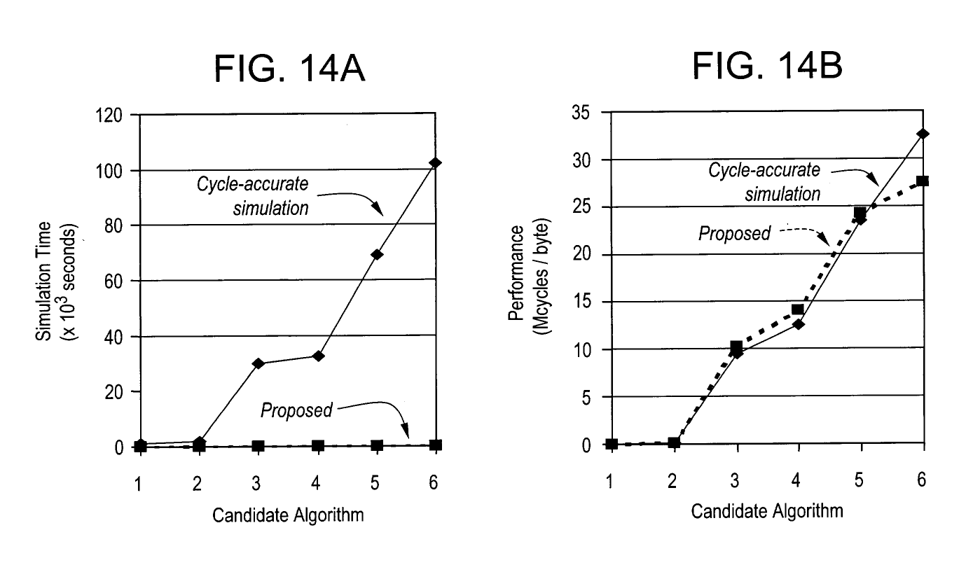

This section presents some results that demonstrate the accuracy and efficiency of performance macro-model based methodology for algorithmic design space exploration. FIG. 14(a) plots the actual and estimated cycle counts per byte of input data, for six configurations in the design space of modular exponentiation. The plot shows that the performance profile determined by the proposed methodology accurately tracks the profile determined by actual target simulation. The mean absolute error in the macro-model-based estimates was only 11.8%. FIG. 14(b) indicates the corresponding speed-up in simulation time obtained by using the proposed methodology. Note that the Y-axis units are multiples of 1000 seconds. Macro-model-based performance estimation completes for all the configurations (not just the six shown) in under 4 hours and 40 minutes. However, using target simulation, we could cover only six configurations in nearly 66 hours of CPU time. On an average, macro-model-based performance estimation was found to be 1407 times faster than target simulation.

FIG. 14 depicts accuracy (cycle count) and efficiency (simulation time) comparisons of the proposed methodology with cycle-accurate target simulation.

IV.H. Conclusions

We presented the system architecture of a programmable security processing platform called MOSES as well as the system-level design methodologies used to design it.

The methodology was constructed using off-the-shelf commercial tools as well as novel in-house components where needed, in order to enable the efficient co-design of optimal cryptographic algorithms and an optimized HW platform architecture. Our experiments demonstrate large performance improvements compared to software implementations on a state-of-the-art embedded processor. We believe that advanced system architectures such as MOSES as well as the system-level design methodologies, such as the one described here, are critical to meeting the challenging objectives and constraints encountered in security processing.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. A programmable security processor for efficient execution of security protocols, wherein the instruction set of the processor is enhanced to contain at least one instruction that is used to improve the efficiency of a public-key cryptographic algorithm, and at least one instruction that is used to improve the efficiency of a private-key cryptographic algorithm.

2. The processor of claim 1 wherein the instruction set also contains at least one instruction that is used to improve the efficiency of a message authentication algorithm.

3. The processor of claim 1 wherein the instruction set also contains at least one instruction that is used to improve the efficiency of random number generation.

4. The processor of claim 1 wherein the instruction set also contains at least one instruction that is used to improve the efficiency of portions of a security protocol other than the cryptographic algorithms, which may include packet processing functions.

5. The processor of claim 1 wherein said instructions are implemented as functional units within the processor.

6. The processor of claim 1 wherein the said functional units are integrated as part of the processor's pipeline.

7. The processor of claim 1 wherein, in addition to the said instructions, at least one co-processor is used to accelerate security protocol computations.

8. The processor of claim 1 wherein, in addition to the said instructions, at least one peripheral unit connected to the processor bus or system bus is used to accelerate security protocol computations.

9. The processor of claim 1 wherein specific instructions are used for each cryptographic algorithm.

10. A layered software library for efficient execution of security protocols that consists of a basic operations layer, a complex operations layer, and a cryptographic algorithms layer.

11. The software library of claim 10 wherein a the specific structure of the software library is provided.

12. A security processing platform consisting of a programmable security processor and a layered software library wherein at least one of the functions in the software library invokes a security-specific instruction of the programmable processor.

13. An electronic system optimized for efficient security processing that comprises of at least one host processor and at least one programmable security processor.

14. The system of claim 13 wherein the security protocol processing functionality is divided between a host processor and a security processor so that the said security processor executes portions of a security protocol other than the cryptographic algorithms, which may include packet processing functions.

15. An electronic system optimized for efficient security processing that comprises of at least one host processor and at least one security processor, wherein at least two distinct allocations of security protocol functionality between a host processor and a security processor exist.

16. The electronic system of claim 15 wherein the said distinct allocations of security protocol functionality are fixed statically.

17. The electronic system of claim 15 wherein the said distinct allocations of security protocol functionality are varied dynamically during system execution.

18. The electronic system of claim 15 wherein the time intervals at which each allocation of security protocol functionality is used are determined statically.

19. The electronic system of claim 15 wherein the time intervals at which each allocation of security protocol functionality is used are determined dynamically during system execution.

20. The electronic system of claim 15 wherein a security processor is enhanced for efficiently interleaving the processing of multiple data streams.

21. The electronic system of claim 20 wherein said enhancement is performed by storing identification and context information for each data stream in the security processor.

22. The electronic system of claim 15 wherein the allocation of security protocol functionality is different for at least two data streams.

23. The electronic system of claim 15 wherein at least two different allocations of security protocol functionality are used for at least one data stream.

24. An electronic system containing at least one programmable security processor, wherein a dedicated memory is attached to a programmable security processor.

25. The system of claim 24 wherein a portion of said dedicated memory can be accessed only by the said programmable security processor.

26. A method of designing an efficient hardware and software architecture for security processing, comprising of algorithm exploration to optimize the software architecture and selection of custom instructions that augment a programmable processor in order to optimize the hardware architecture.

27. The method of claim 26 wherein algorithm exploration is performed through native simulation of the source code of each candidate algorithm while using performance macro-models to estimate performance.

28. The method of claim 26 wherein custom instruction selection is performed by constructing a function call graph representation of the software, formulating custom instruction candidates for selected functions in the call graph, and performing a global custom instruction selection to determine the final set of custom instructions.

29. The method of claim 28 wherein the said formulation of custom instruction candidates is used to generated area vs. delay curves for the selected functions.

30. The method of claim 28 wherein the said global custom instruction selection is performed by propagating area vs. delay curves upwards to the root of the call graph and choosing the final custom instructions based on the area vs. delay curve for the root.
